(19) United States
(12) Patent Application Publication
(10) Pub. No.: US 2024/0023045 A1
(43) Pub. Date: Jan. 18, 2024

(54) TIMING ADVANCE IN MULTIPLE TRANSMISSION POINT OR PANEL CONFIGURATION FOR COMMUNICATION NETWORK

(71) Applicant: Telefonaktiebolaget LM Ericsson (publ), Stockholm (SE)

(72) Inventors: Icaro Leonardo DA SILVA, Solna (SE); Pradeepa RAMACHANDRA, Linköping (SE); Helka-Liina MÄÄTTÄNEN, Espoo (FI); Claes TIDESTAV, Bålsta (SE); Siva MURUGANATHAN, Stittsville (CA)

(21) Appl. No.: 18/039,620

(22) PCT Filed: Dec. 14, 2021
(86) PCT No.: PCT/IB2021/061716

§ 371 Date: May 31, 2023

Related U.S. Application Data
(60) Provisional application No. 63/125,385, filed on Dec. 14, 2020.

(51) Int. Cl. H04W 56/00; H04B 7/06

(52) U.S. Cl. CPC H04W 56/0045; H04B 7/06968

(57) ABSTRACT

A method performed by a communication device is provided. The communication device is configured with a plurality of transmission configurations associated with one or more cells, each cell associated with one or more physical cell identities, PCIs. The method includes receiving a signal for lower layer mobility. The signal including an indication of a transmission configuration to be activated from the plurality of transmission configurations; and, in response to the indicated transmission configuration, determining if a timing advance, TA, is valid or invalid.

### RELATED APPLICATIONS

This application claims the benefit of U.S. provisional patent application Ser. No. 63/125,385 filed on Dec. 14, 2020, the disclosure of which is hereby incorporated by reference in its entirety.

### TECHNICAL FIELD

The present disclosure relates generally to managing a timing advance (TA) in a multiple transmission point or panel (TRP) configuration for a communication network, and related methods and apparatuses.

### BACKGROUND

For time alignment and uplink (UL) synchronization in new radio (NR), different user equipment (UE(s)) in the same cell may typically be located at different positions within the cell and then with different distances to the base station (e.g., NR gNodeB (gNB)). The transmissions from the different UEs thus suffer from different delays until they reach the base station.

### SUMMARY

Certain aspects of the disclosure and their embodiments may provide solutions to these and other challenges.

According to some embodiments of the present disclosure, a method performed by a communication device for managing a TA in a multiple TRP configuration for a communication network is provided. The method includes receiving, from a network node, information for at least one non-serving cell, the information comprising at least one of (1) a non-serving cell configuration for the at least one non-serving cell, (2) at least one transmission configuration indicator, TCI, state configuration associated to a quasi collocation, QCL, source associated to the at least one non-serving cell, and (3) a signal for lower layer mobility associated to a change of a TCI state for the at least one non-serving cell having multiple physical cell identities, PCIS, the signal indicating to the communication device a new TCI state having a QCL source of the new TCI state associated to a synchronization signal block (SSB) that is associated to the at least one non-serving cell. The method further includes determining, based on the received information from the network node, whether a TA is valid or is invalid for the at least one non-serving cell.

According to some embodiments of the present disclosure, a method performed by a communication device configured with a plurality of transmission configurations associated with one or more cells, each cell associated with one or more PC's is provided. The method comprises receiving a signal for lower layer mobility. The signal comprising an indication of a transmission configuration to be activated from the plurality of transmission configurations. The method further comprises, in response to the indicated transmission configuration, determining if a TA is valid or invalid.

Corresponding embodiments of inventive concepts for a communication device, computer products, and computer programs are also provided.

Operational advantages that may be provided by one or more embodiments of the present disclosure may include that a UE can manage the time alignment for non-serving cell(s) that the UE may perform Layer 1 (L1)/Layer 2 (L2) centric mobility. In some embodiments, this can be done without necessarily having to rely on random access to the non-serving cell which can reduce the resource usage in the target cell, reduce the latency required to be scheduled in the target cell, and reduce the power consumption at the UE.

### BRIEF DESCRIPTION OF THE DRAWINGS

The accompanying drawings, which are included to provide a further understanding of the disclosure and are incorporated in a constitute a part of this application, illustrate certain non-limiting embodiments of inventive concepts. In the drawings:

FIG. 1 is a signaling flow diagram of a time alignment of UL transmissions for a case (a) without TA and for a case (b) with TA;

FIG. 2 is a block diagram illustrating TCI states configured as part of a CellGroupConfig, a distributed unit (DU) configuration in a centralized unit—distributed unit (CU-DU) split architecture, and conveyed to the UE via an radio resource control reconfiguration (RRCReconfiguration);

FIG. 3 is a signalling diagram of TCI states configurations signaled as part of the physical data shared channel (PDSCH) configuration;

FIG. 4 is a signalling diagram illustrating a TCI state activation via MAC CE;

FIG. 5 is a block diagram illustrating an example of multi-PDCCH based multi-TRP transmission with a single scheduler;

FIG. 6 is a block diagram illustrating an example of multi-PDCCH based multi-TRP transmission with independent schedulers;

FIG. 7 is a block diagram illustrating an example of PDSCH transmission with multi-downlink control information (DCI) with multiple TRPs;

FIG. 8 is a block diagram of an example of a single-PDCCH scheduling two different PDSCHs;

FIGS. 9-14 are signalling diagrams illustrating a method of a communication device in accordance with some embodiments of the present disclosure;

FIG. 15 is a block diagram of a wireless network, including a communication device and a network node, in accordance with some embodiments of the present disclosure;

FIG. 16 is a flowchart of operations for managing a TA in a multiple transmission points or panels (TRPs) configuration for a communication network, in accordance with some embodiments of the present disclosure; and

FIG. 17 is a block diagram of a virtualization environment in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter. The term “communication device” is used in a non-limiting manner and, as explained below, can refer to any type of radio communication terminal. The term “communication device” herein may be interchangeable replaced with the terms “user equipment (UE)”.

For time alignment and UL synchronization in NR, in order to make sure that the UL transmissions from a UE reaches the base station within the corresponding receive window for the base station, an UL timing control procedure is used. This can avoid intracell interference occurring, both between UEs assigned to transmit in consecutive subframes and between UEs transmitting on adjacent subcarriers.

In L1 and/or L2-centric inter-cell mobility (also referred to herein as “L1/L2 centric inter-cell mobility”), the network should be able to indicate to the UE, via L1/L2 signaling, a Transmission Configuration Indicator (TCI) state (e.g., by indicating a TCI identity (Id) configured via RRC) whose Quasi-Co-Location (QCL) source is associated to a non-serving cell, that is a cell different from a serving cell the UE is connected to, like the Primary Cell (PCell).

In a case where the UE is configured with non-serving cells wherein it is possible to perform L1/L2 centric mobility and, if the UE receives that TCI state indication for a non-serving cell, the UE would not be UL synchronized, the UE may generate interference in the UL upon transmissions (e.g. on the UL channels such as Physical UL Control Channel (PUCCH) and/Physical UL Shared Channel (PUSCH)), which may degrade the performance of that UE and/or other UEs connected to that target cell.

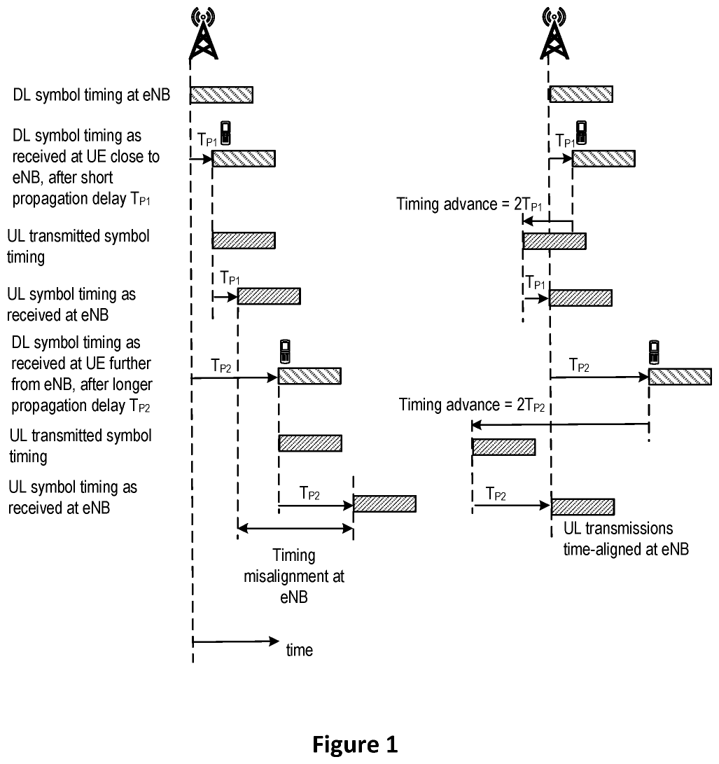

In some systems, time alignment of the UL transmissions can be achieved by applying a TA at the UE transmitter, relative to the received downlink (DL) timing. The main role of this is to counteract differing propagation delays between different UEs, as shown in the example of FIG. 1 for an Long Term Evolution (LTE) eNodeB (eNB).

FIG. 1 illustrates time alignment of UL transmissions for a case (a) without TA and for a case (b) with TA.

In order to achieve the time alignment, to obtain UL synchronization, the base station (e.g. eNB) derives the TA value that the UE needs to use for the UL transmissions in order to reach the base station within the receive window and indicates this to the UE. When the UE first accesses a cell, it uses the random-access procedure where the received Msg1 (the physical random access channel (PRACH) preamble) is used by the base station to determine the UE's initial TA to use for UL transmissions in the cell. During the connection, the base station then continuously monitors whether the UE needs to advance/delay the UL transmissions, in order to compensate for changes in propagation delay, and indicates to the UE if there is a need to change the TA value.

When the UE has a connection to several different serving cells the same TA value can sometimes be used for more than one of those cells, e.g. due to that they are colocated and thus always would have the same distance to a UE. Such cells can then be configured as belonging to the same Timing Advance Group (TAG). The configuration of TAGs is done per cell group, e.g. serving cells may be configured as belonging to the same TAG only if they belong to the same cell group (master cell group (MCG) or secondary cell group (SCG)), as further discussed herein.

When the UE does not perform any UL transmissions for some time in a serving cell, the TA value that the UE used earlier may no longer be accurate, e.g. due to that the UE has moved and thus have a different propagation delay. In that case, if the UE performs an UL transmission using the latest received TA value it may reach the base station outside the receive window and thus not be correctly received by the base station. The transmission may then even be interfering with other UL transmissions (from other UEs). A timer timeAlignmentTimer is therefore configured for each TAG, to indicate how long the UE can consider itself to be UL time aligned to serving cells belonging to the associated TAG, without receiving any updates to the TA value. The timeAlignmentTimer thus indicates how long time the UE may consider a received TA value as valid. If the UE does not receive an updated value before timeAlignmentTimer expires, the UE is no longer UL synchronized to the serving cells belonging to the corresponding TAG.

3GPP TS 38.300 V16.3.0 describes a similar approach for NR.

Initial TA and TAG configuration is now described.

The initial TA is obtained when the UE performs random access, e.g. when performing a transition from IDLE (or INACTIVE) to CONNECTED state. After a UE has first synchronized its receiver to the DL transmissions received from the gNB (e.g. by monitoring the SSBs of the cell the UE wants to access), the initial timing advance is set by the UE transmitting a random access preamble from which the gNB estimates the UL timing value contained within the Random Access Response (RAR) message. This allows the timing advance to be configured by the gNB. (see 3GPP TS 38.321 V16.2.1 for more detail). The following sections of 3GPP TS 38.321 V16.2.1 are hereby incorporated by reference: Sections 5.1.4 “Random Access Response reception” and “Maintenance of Uplink Time Alignment” (section 5.2); Section 6.2.3 “MAC payload for Random Access Response”; Section 6.1.3.4 “Timing Advance Command MAC CE” (including, but not limited to FIG. 6.1.3.4-1. Additionally, Section 4.2 of 3GPP TS 38.213 V16.3.0 concerns transmission timing adjustments and is hereby incorporated by reference. For example, the TAG configuration is a list of TAGs (e.g., tag-ToAddModList of Information Element (IE) SEQUENCE (SIZE (1 . . . maxNrofTAGs)) OF TAG), each associated to a TAG identifier (tag-Id of IE TAG-Id) and a time alignment Timer value (e.g., timeAlignmentTimer of IE TimeAlignmentTimer, whose values are ms500, ms750, ms1280, ms1920, ms2560, ms5120, m510240, infinity).

Then, each serving cell configuration can have a TAG identifier associated e.g. special cell (SpCell) and/or an SCell of the cell group. And, two serving cells having configured the same TAG identifier will be assumed by the UE to have the same time alignment timer and belong to the same TAG. This configuration is provided to the UE in each dedicated serving cell configuration IE ServingCellConfig, also part of CellGroupConfig for each serving cell, as shown in 3GPP 38.331 V16.2.0.

UL time alignment maintenance is now discussed.

After the UE is configured with its serving cell(s) for a given cell group (e.g., (MCG) and/or SCG), the UE obtains the initial TA value via RAR, and is configured with the association between serving cells and TAG identifiers, the UE needs to maintain the time alignment according to the TA procedure defined in 5.2 in TS 38.321 V16.2.1. TA is adjusted while the UE is connected to a serving cell either by an explicit MAC CE from the network (e.g., if the network detects a possible misalignment) and/or by the UE (e.g. when the time alignment timer timeAlignmentTimer for a given TAG expires).

Upon reception of the TA Command (e.g., a MAC CE) the UE applies the command (including new value(s)) and start/re-start the TA timer. Further details of the maintenance procedure, after the initial TA are described in Section 5.2 of 3GPP TS 38.321 V16.2.1 and are hereby incorporated by reference.

Beam indications, QCL source and TCI states will now de described.

Several signals can be transmitted from the same base station antenna from different antenna ports. These signals can have the same large-scale properties, for instance in terms of Doppler shift/spread, average delay spread, or average delay, when measured at the receiver. These antenna ports are then said to be QCL.

The network can then signal to the UE that two antenna ports are QCL so that the UE interprets that signals from these will have some similar properties. If the UE knows that two antenna ports are QCL with respect to a certain parameter (e.g., Doppler spread), the UE can estimate that parameter based on a reference signal transmitted by one of the antenna ports and use that estimate when receiving another reference signal or physical channel from the other antenna port. Typically, the first antenna port is represented by a measurement reference signal such as a channel state information-reference signal (CSI-RS) (known as source RS) and the second antenna port is a demodulation reference signal (DMRS) (known as target RS) for PDSCH or PDCCH reception.

For instance, if antenna ports A and B are QCL with respect to average delay, the UE can estimate the average delay from the signal received from antenna port A (the source RS) and assume that the signal received from antenna port B (target RS) has the same average delay. This is useful for demodulation since the UE can know beforehand the properties of the channel when trying to measure the channel utilizing the DMRS, which may help the UE in for instance selecting an appropriate channel estimation filter.

Information about what assumptions can be made regarding QCL is signaled to the UE from the network. In NR, four types of QCL relations between a transmitted source RS and transmitted target RS are defined:
Type A: {Doppler shift, Doppler spread, average delay, delay spread}
Type B: {Doppler shift, Doppler spread}
Type C: {average delay, Doppler shift}
Type D: {Spatial Receive (Rx) parameter}

QCL type D was introduced to facilitate beam management procedures with analog beamforming and is known as spatial QCL. There is currently no strict definition of spatial QCL, but the understanding is that if two transmitted antenna ports are spatially QCL, the UE can use the same Rx beam to receive signals associated to them. This is helpful for a UE that uses analog beamforming to receive signals, since the UE need to adjust its Rx beam in some direction prior to receiving a certain signal. If the UE knows that the signal is spatially QCL with some other signal it has received earlier, then it can safely use the same Rx beam to also receive this signal. Note that for beam management, the discussion mostly revolves around QCL Type D, but it is also necessary to convey a Type A QCL relation for the RSs to the UE, so that it can estimate all the relevant large-scale parameters. In other words, one could say that two signals are transmitted in the same direction or via the same DL beams when these are QCL Type D. Hence, the network may give this relation between a channel to be decoded (e.g., PDCCH/PDSCH) and a signal that is known to be transmitted in a given direction that may be used as reference by the UE, like a CSI-RS, SSB, etc.

Typically, this is achieved by configuring the UE with a CSI-RS for tracking (TRS—Tracking Reference Signal) for time/frequency offset estimation (and/or SSB). To be able to use any QCL reference, the UE would have to receive it with a sufficiently good signal to interference plus noise ratio (SINR). In many cases, this means that the TRS has to be transmitted in a suitable beam to a certain UE.

The concept of a TCI state is related to the concept of QLC source. Each of the M states in the list of TCI states can be interpreted as a list of M possible beams transmitted in the DL from the network and/or a list of M possible TRPs used by the network to communicate with the UE. The M TCI states can also be interpreted as a combination of one or multiple beams transmitted from one or multiple TRPs.

To introduce dynamics in beam and TRP selection/switching, the UE can be configured through RRC signaling with M TCI states (e.g., during connection setup, resume, reconfiguration, handovers, etc.), where M is up to 128 in frequency range 2 (FR2) for the purpose of PDSCH reception and up to 8 in frequency range 1 (FR1), depending on UE capability.

In RRC, TCI states are currently configured as part of the so-called CellGroupConfig, which is a DU configuration (i.e., decided by the baseband unit) in a CU-DU split architecture, and conveyed to the UE via for example an RRCResume (i.e., during transition from Inactive to Connected) or RRCReconfiguration (e.g., during handovers, intra-cell reconfigurations or transitions from Idle to Connected). An example can be found in 3GPP 38.331 V16.2.0.

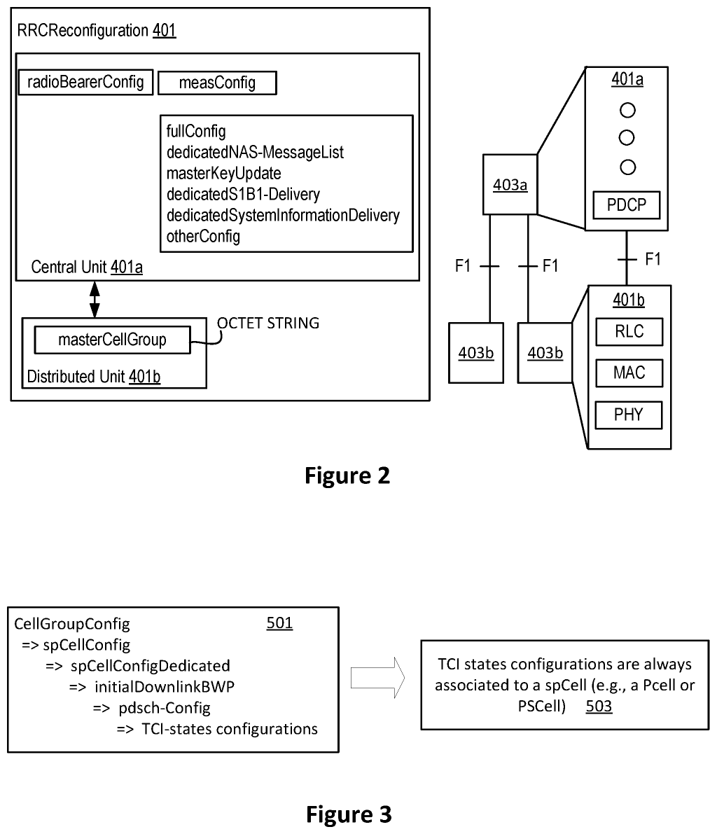

FIG. 2 is a block diagram illustrating TCI states configured as part of the so-called CellGroupConfig, a DU configuration in a CU-DU split architecture, and conveyed to the UE via for example a RRCReconfiguration.

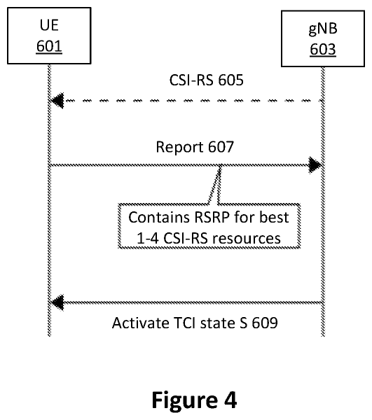

The TCI states configurations are signaled as part of the PDSCH configuration, which is configured per each DL Bandwidth Part (BWP) of a SpCell (i.e. a PCell or a PSCell), where an SpCell can be comprised of one or multiple DL BWPs. In terms of signaling this is structured as illustrated in the block diagram of FIG. 3 (e.g., for the initial DL BWP case).

The PDSCH configuration (for a given DL BWP) comprises a list of TCI states to be added or modified.
A second list of TCI states is configured for PDCCH (also per DL BWP). The PDCCH-Config can include a list referred to as Control Resource Sets (CORESET).

Each CORESET contains a length (1, 2, or 3 OFDM symbols) as well as a frequency-domain allocation of PDCCH (i.e., frequency in which the PDCCH is transmitted and shall be monitored by the UE). The TCI state configuration indicates which TCI is used to receive the PDCCH candidates transmitted in that CORESET. Each CORESET can have a different TCI state configured/activated, enabling the possibility to use different transmit beams for different PDCCH candidates. In the CORESET configuration, there is a pointer (TCI-State ID) to the list of TCI configurations provided in PDSCH, as included, e.g. in a “tci-StatesPDCCH-ToAddList” row.

Each TCI state configuration contains a pointer, known as TCI State ID (TCI-Stateld), which points to the TCI state. That pointer may be used, for example, to refer to a TCI configuration in a CORESET configuration. In other words, the TCI configurations are provided in the PDSCH configuration in a given DL BWP. And, for PDCCH, the CORESET configuration contains a TCI state pointer to a configured TCI state in PDSCH.

Each TCI state contains the previously described QCL information, i.e. one or two source DL RS, where each source RS is associated with a QCL type. For example, a TCI state contains a pair of reference signals, each associated with a QCL type, e.g. two different CSI-RSs {CSI-RS1, CSI-RS2} is configured in the TCI state as {qcl-Type1,qcl-Type2}={Type A, Type D}. It means the UE can derive Doppler shift, Doppler spread, average delay, delay spread from CSI-RS1 and Spatial Rx parameter (i.e. the Rx beam to use) from CSI-RS2. In terms of RRC signaling, a TCI state is represented by an IE called TCI-State.

In the TCI-State IE definition, there is a field called cell. According to the definition in TS 38.331 V16.3.0, the field called cell in the QCL configuration (i.e., cell field of IE ServCellIndex) is the UE's serving cell in which the Reference Signal that is QCL source is being configured. If the field is absent, it applies to the serving cell in which the TCI-State is configured (i.e., the SpCell of the cell group, not an indexed SCell). The RS can be located on a serving cell other than the serving cell in which the TCI-State is configured only if the QCL-Type is configured as type D (see TS 38.214 V16.3.0 section 5.1.5).

TCI state/beam indication/beam switching via MAC CE is now described.

Once the UE is configured with a CellGroupConfig (e.g., in RRCResume, during transition from Inactive to Connected, or in a handover), and spCellConfig with PDSCH and PDCCH configurations per BWP having possible TCI states associated to different transmission DL beams where these channels need to be detected (or in other words, how the UE should consider its Rx beam to decode these channels), the UE needs to know how the network is providing scheduling information. All these TCI states that are configured are not considered to be used/monitored all the time. Hence, a signaling efficient activation/deactivation procedure is defined in NR.

The network can activate via MAC CE one TCI state for PDCCH (i.e., provides a TCI for PDCCH) and up to eight active TCI states for PDSCH. The number of active TCI states the UE supports is a UE capability, but the maximum is 8.

FIG. 4 is a signalling diagram illustrating a TCI state activation via MAC CE. Network node 603 (e.g., a gNB) transmits 605 CSI-RS in narrow beams to UE 601. UE 601 reports 607 a measurement to network node 603. The report contains reference signal received power (RSRP) for the best 1-4 CSI-Rs resources, for example. network node 603 chooses a CSI-RS resource from the measurement. network node 603 knows in which beam it transmitted that CSI-RS resource, and maps the beam to an SSB. Network node 603 determines the TSI state S that includes the corresponding SSB index. Network node 603 activates 609 TCI state S.

The MAC CE structure for the activation of UE-specific PDCCH TCI state is shown in TS 38.321 V16.2.1.

L1/L2-centric mobility is now described.

For purposes of this disclosure, the UE receives a L1/L2 signaling (instead of RRC signaling) indicating a TCI state (e.g. for PDCCH) possibly associated to an SSB whose PCI is not necessarily the same as the PCI of the cell the UE has connected to e.g. via connection resume or connection establishment. In other words, L1/L2-centric inter-cell mobility procedure can be interpreted as a beam management operation expanding the coverage of multiple SSBs associated to multiple PC's (e.g. possibly associated to the same cell or different cells).

Inter-cell Multi-TRP will now be described.

In Rel-17, the work for multi-TRP done in Rel-16 is being extended to an inter-cell scheme. Multi-TRP transmission is essentially non-coherent Joint Transmission (NC-JT) over multiple TRPs. NC-JT refers to multiple input multiple output (MIMO) data transmission over multiple TRPs in which different MIMO layers are transmitted over different TRPs. Two ways of scheduling NC-JT multi-TRP transmission are specified in NR Rel-16: multi-PDCCH based multi-TRP transmission and single-PDCCH based multi-TRP transmission.

Multi-PDCCH based multi-TRP transmission will now be described.

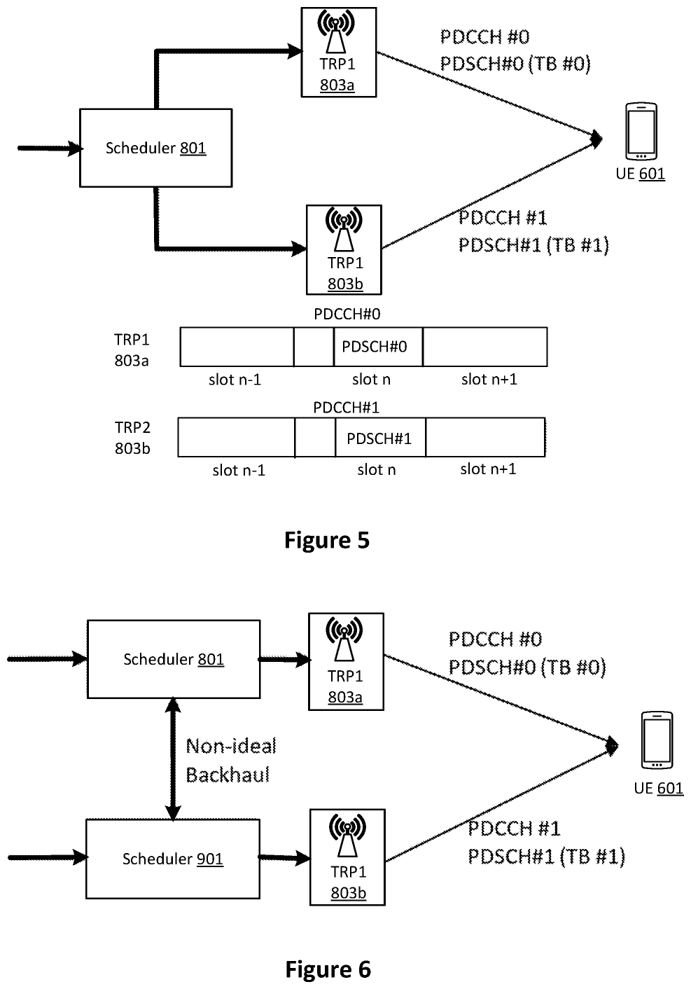

FIG. 5 is a block diagram illustrating an example of multi-PDCCH based multi-TRP transmission with a single scheduler 801. Data are sent to a UE 601 over two TRPs 803a and 803b, each TRP carrying one Transport Block (TB) mapped to one code word. When the UE 601 has 4 receive antennas while each of the TRPs has only 2 transmit antennas, the UE can support up to 4 MIMO layers but each TRP can maximally transmit 2 MIMO layers. In this case, by transmitting data over two TRPs to the UE, the peak data rate to the UE can be increased as up to 4 aggregated layers from the two TRPs can be used. This is beneficial when the traffic load and thus the resource utilization, is low in each TRP. In this example, a single scheduler is used to schedule data over the two TRPs. One PDCCH is transmitted from each of the two TRPs in a slot, each schedules one PDSCH. This is referred to as a multi-PDCCH or multi-DCI scheme in which a UE receives two PDCCHs and the associated two PDSCHs in a slot from two TRPs.

FIG. 6 is a block diagram illustrating an example of multi-PDCCH based multi-TRP transmission with independent schedulers 801 and 901. Independent schedulers 801 and 901 are used in each TRP 803a and 803b. In this case, only semi-static to semi-dynamic coordination between the two schedulers can be done due to the non-ideal backhaul, i.e., backhaul with large delay and/or delay variations which are comparable to the cyclic prefix length or in some cases even longer, up to several milliseconds.

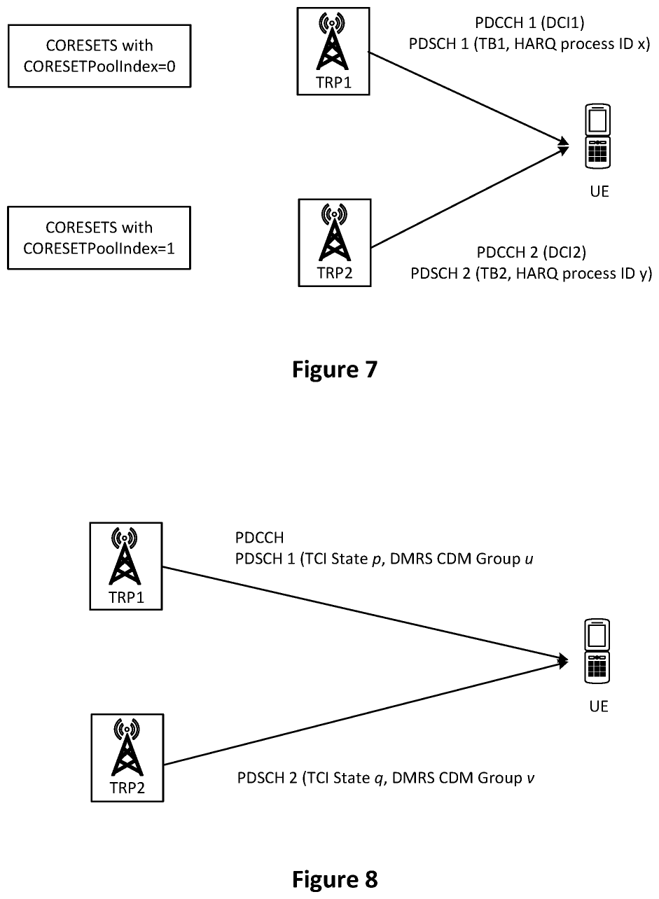

In NR Rel-16, multi-DCI scheduling is for multi-TRP in which a UE may receive two DC's each scheduling a PDSCH/PUSCH. Each PDCCH and PDSCH are transmitted from the same TRP. FIG. 7 is a block diagram illustrating an example of PDSCH transmission with multi-DCI with multiple TRPs. FIG. 7 shows PDSCH 1 being scheduled by PDCCH 1 from TRP1 and PDSCH 2 being scheduled by PDCCH 2 from TRP2. The two PDSCHs may be fully, partially or non-overlapping in time and frequency. When the two PDSCHs are fully or partially overlapping, a same DMRS resource configuration is assumed with DMRS ports of the two PDSCHs in different code division multiplexing (CDM) groups. Multi-DCI scheduling can also be used to schedule PUSCH towards different TRPs. In the case of PUSCH scheduling, the PUSCH transmissions towards different TRPs are time-division-multiplexed.

For multi-DCI operation, a UE needs to be configured with two CORESET pools, each associated with a TRP. Each CORESET pool is a collection of CORESETs that belongs to the same pool. A CORESET pool index can be configured in each CORESET with a value of 0 or 1. For the two DC's in the above example, they are transmitted in two CORESETs belonging to different CORESET pools (i.e. with CORESETPoolIndex 0 and 1 respectively). The two PDSCHs belong to two different HARQ processes.

Single-PDCCH based multi-TRP transmission will now be described.

For single-PDCCH based multi-TRP transmission, the single PDCCH is received from one of the TRPs while PDSCH(s) will be received from both TRPs. FIG. 8 is a block diagram of an example of a single-PDCCH scheduling two different PDSCHs. FIG. 8 shows an example where a DCI received by the UE in PDCCH from TRP1 schedules two PDSCHs. The first PDSCH (PDSCH1) is received from TRP1 and the second PDSCH (PDSCH2) is received from TRP2.

The intercell aspect of Rel-17 refers to the case when these two TRPs are associated to different SSB(PCI)s. That is, the TCI state that refers to transmission from TRP 1 or TRP 2 is quasi colocated to a reference signal that either is one of the SSB beams with the PCI belonging to that TRP, or another reference signal like CSI-RS or DMRS that has root quasi colocation assumption to one of the SSB beams with PCI belonging to that TRP.

The present disclosure uses the terminology in the NR specification as main examples and refers to the Rel-17 feature. However, this feature may also be applicable in the context of 6G research, which is often labelled as Distributed-MIMO (D-MIMO) and cell-less mobility. The method of various embodiments of the present disclosure may also be relevant for other multi-beam transmission schemes, such as in Tera Hertz communications system, which may be the case in some frequencies possibly allocated to 6G and/or 5G enhancements.

The terms serving and non-serving cell include an alternative meaning to legacy interpretation. This is because the formulation of the work item description for Rel-17 MIMO uses the term non-serving cell in an undefined way. During Rel-17, the actual interpretation of non-serving cell may be clarified. As used in the present disclosure, the term may refer to an actual non-serving cell, to a plurality of serving cells configured for the UE that are interpreted differently from CA configuration (e.g., SCell), or to an additional SSB configured in a serving cell configuration which has a different PCI than the cell defining SSB of that serving cell.

The term “beam” can correspond to a reference signal that is transmitted in a given direction. For example, it may refer to an SS/PBCH Block (SSB) or layer 3 configured CSI-RS. During a half-frame, different SSBs may be transmitted in different spatial directions (i.e. using different beams, spanning the coverage area of a cell). That can correspond to different SSBs meaning different beams, or that different SSBs being possibly transmitted in different beams so that a beam measurement corresponds to an SSB measurements (e.g. an SS-RSRP).

The term PCI and/or PCI of an SSB correspond to the PCI encoded by a PSS and an a SSS that are comprised in an SSB as defined in TS 38.211 V16.3.0.

The terms “cells” or a “set of cells” in which the UE can be configured to perform L1/L2 centric mobility may be called a set of intra-frequency neighbour cells from which the UE can perform measurements on and can perform a handover/reconfiguration with sync to, or a set of intra-frequency non-serving cells or simply a set of non-serving cells. These may be a set of inter-frequency neighbors that are non-serving cells wherein their SSB's frequency location (e.g. SSB absolute radio frequency channel number (ARFCN)) are not in the same frequency location as a serving cell SSB frequency location (i.e. different ARFCN).

The terms CORESET and PDCCH configuration are used interchangeably to indicate a control channel configuration, including an indication of frequency and time locations the UE monitors to listen to scheduling from the network, e.g. when it is in Connected state. A CORESET can be defined as a time/frequency control resource set in which to search for DCI (see TS 38.213 V16.3.0, clause 10.1). The CORESET configuration may be provided to the UE in the IE ControlResourceSet used to configure a time/frequency control resource set (CORESET).

The term L1/L2 inter-cell centric mobility or simply L1 mobility or, L1/L2 centric mobility refers to a procedure where the UE change cells (e.g., changes SpCell, PCell change, or PSCell change) upon reception of a L1 and/or L2 signaling, such as upon the reception of a MAC CE.

Determining whether the TA is valid for a given non-serving cell corresponds to determining whether the UE is UL synchronized for transmissions (e.g., in PUCCH and/or PUSCH and/or other UL channels) in the non-serving cell.

Regarding ASN.1 encoding (for the examples showing signaling), consider TS 38.331 Rel-16 specifications for RRC as a reference for the omitted IEs and field in the messages and/or IEs that are proposed to be extended to implement the methods and embodiments of this disclosure.

The following can be considered for a serving cell. For a UE in RRC_CONNECTED not configured with CA and/or Dual Connectivity (CA/DC) there is only one serving cell, i.e. the PCell. For a UE in RRC_CONNECTED configured with CA/DC, the term ‘serving cells’ is used to denote the set of cells comprising of the SpCells (e.g. PCell, PSCell) and all SCell(s). A non-serving cell is non-serving in that it is a cell that is not a PCell, not a PSCell, and not an SCell(s).

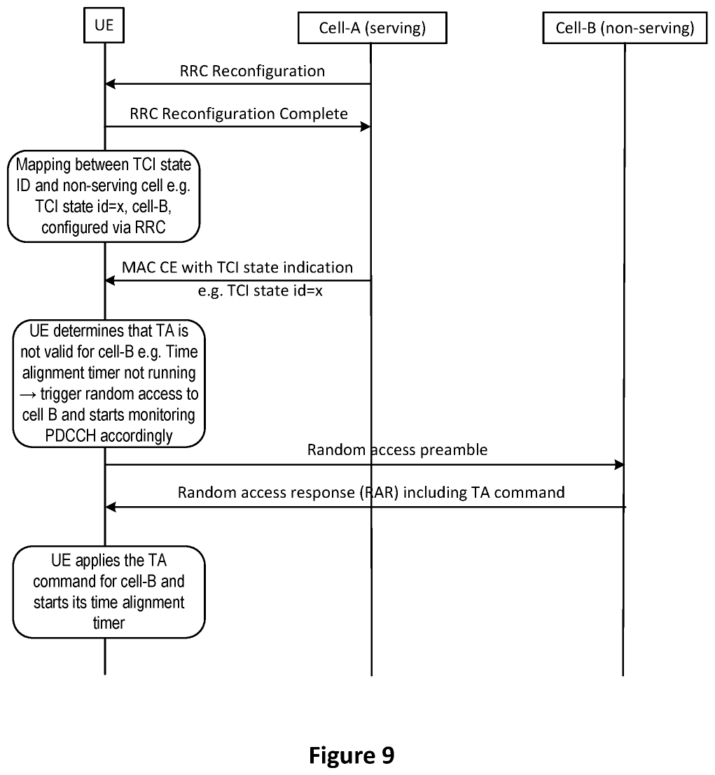

FIG. 9 is a signalling diagram illustrating an example embodiment. The UE receives a RRC reconfiguration from serving cell-A. The UE performs the reconfiguration, and responds to serving cell-A with a message including that RRC reconfiguration is complete. The RRC reconfiguration includes a mapping between a TCI state ID and a non-serving cell (e.g., TCI state id=x, non-serving cell-B, as illustrated in FIG. 9). The UE receives a MAC CE with a TCI state indication (e.g., TCI state id=x). The UE triggers a random access to the non-serving cell-B upon reception of the MAC CE, within a short time (e.g., immediately) as part of the L1/L2 centric inter-cell mobility procedure (e.g., upon reception of the MAC CE (or any other L1/L2 signaling)). Non-serving cell-B signals a random access response (RAR), including a TA command, to the UE. The UE applies the TA command for non-serving cell-B, and the UE starts its time alignment timer.

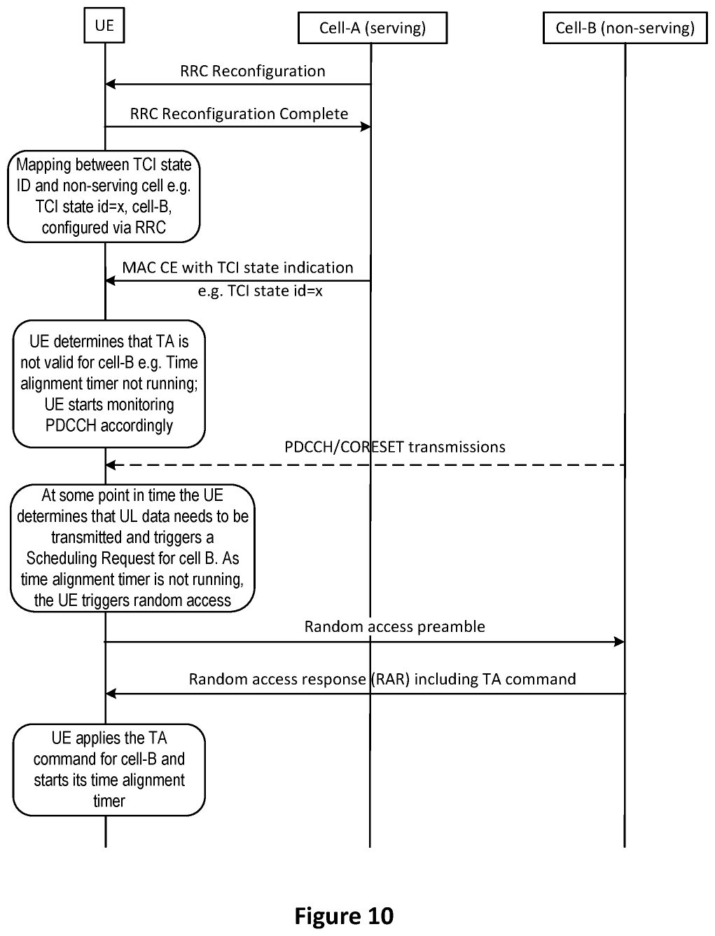

In some embodiments, the UE does not trigger a random access to the non-serving cell upon reception of the L1/L2 centric inter-cell mobility, such as the MAC CE, but first waits until there is a need for UL transmission in the non-serving cell. FIG. 10 is a signaling diagram illustrating such an example embodiment.

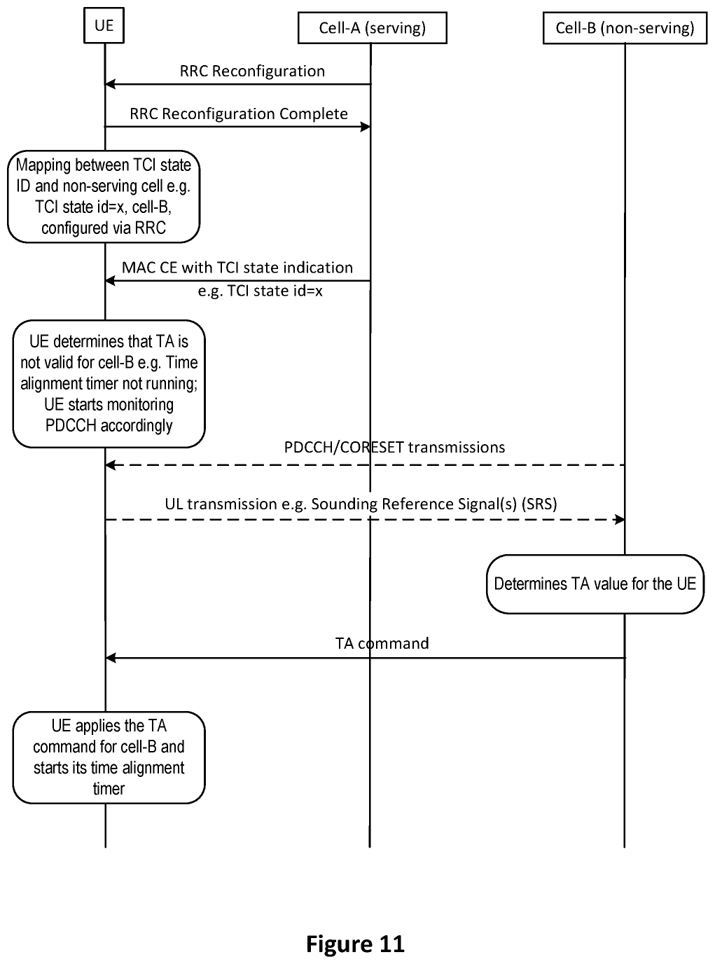

In some embodiments, after receiving the MAC CE with the indication of a TCI state, the UE determines whether the TA is valid or invalid by determining whether a time alignment timer is running. If the timer is running the UE considers the TA as valid; if the timer is not running, the UE considers the TA as not valid. FIG. 11 is a signaling diagram illustrating such an example embodiment. In this example embodiment, the MAC entity used in the serving cell-A remains the same as the MAC entity in the target cell (e.g., the indicated non-serving cell-B). Hence, the time alignment is valid for the MAC entity before and after the L1/L2 centric inter-cell mobility.

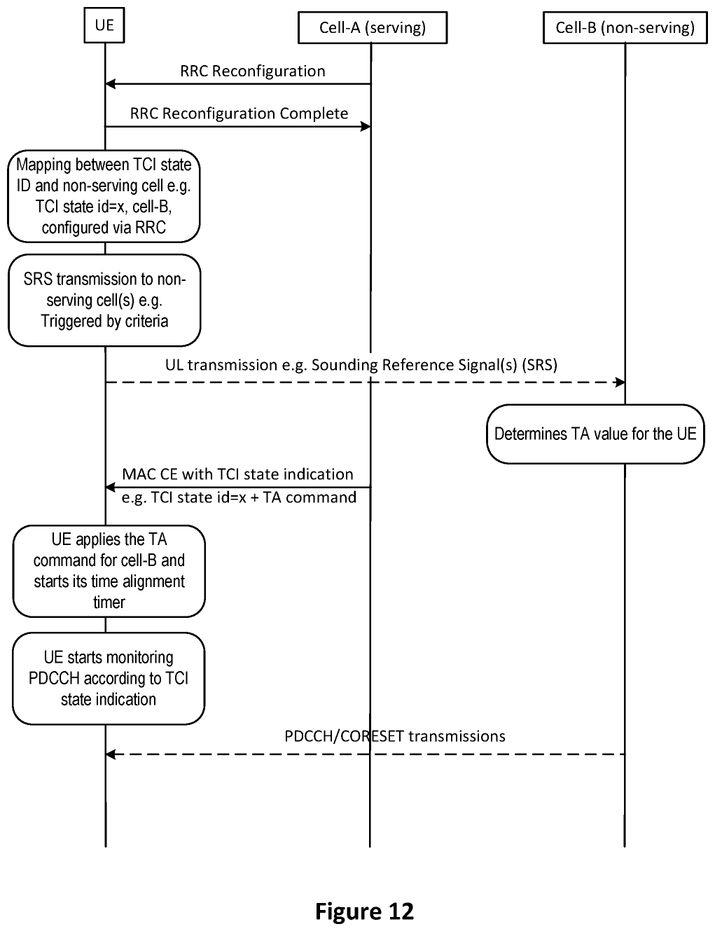

In some embodiments, the network calculates the TA for a non-serving cell that is a target cell for L1/L2 centric inter-cell mobility via the reception of UL signal(s) from the UE (e.g., SRS(s) that needs to be transmitted before the UE receives the command for performing L1/L2 centric inter-cell mobility). In this embodiment, the target cell (which used to be a non-serving cell configured for L1/L2 centric inter-cell mobility) may be able to calculate the TA for that UE (e.g., based on the detection of SRS transmissions and/or other UL transmissions (e.g., preambles) from that UE and/or a knowledge about timing differences between source and target cells). FIG. 12 is a signaling diagram illustrating such an example embodiment.

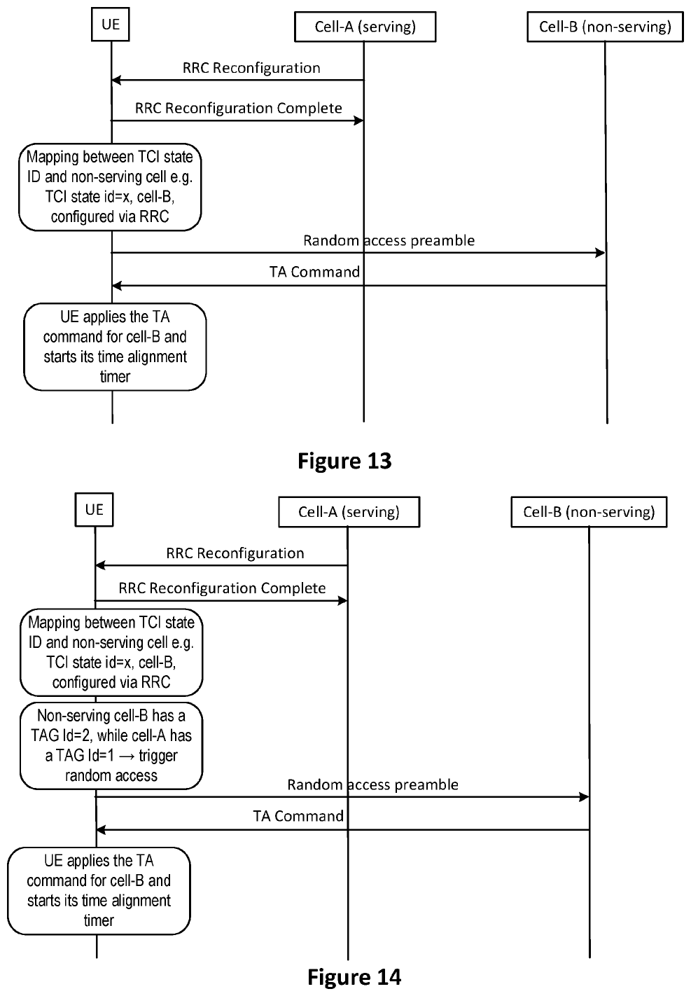

In another embodiment that is a contention based random access procedure, the UE transmits a specially defined preamble (e.g., from a group of preambles assigned for that purpose) as a way to indicate to the network that the UE is not trying to access the cell, but rather needs to obtain a TA. Then, the UE receives the TA command, without the need to include other information typically included in a RAR. FIG. 13 is a signaling diagram illustrating such an example embodiment.

In some embodiments, the UE obtains a TA for the non-serving cell upon the reception of the message configuring the non-serving cell by triggering random access towards the non-serving cell, only if the non-serving cell is associated to a time alignment group that is not the same time alignment group of the serving cell. FIG. 14 is a signaling diagram illustrating such an example embodiment.

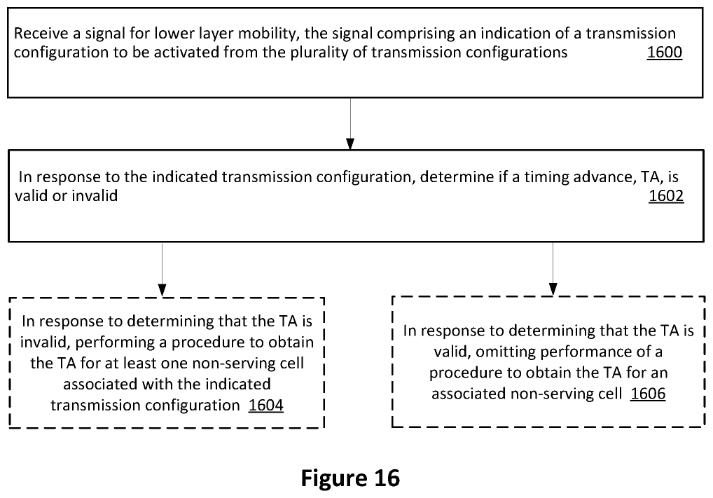

FIG. 16 is a flowchart of operations of a method performed by a communication device (e.g., 601, 4110) configured with a plurality of transmission configurations associated with one or more cells, each cell associated with one or more PCIS. The method includes receiving (1600) a signal for lower layer mobility. The signal comprises an indication of a transmission configuration to be activated from the plurality of transmission configurations. The method further includes, in response to the indicated transmission configuration, determining (1602) if a timing advance, TA, is valid or invalid.

In some embodiments, the method further comprises obtaining the plurality of transmission configurations. For example, the UE can obtain the plurality of transmission configurations by receiving them from a network node.

In some embodiments, the indication comprises at least one transmission configuration indicator, TCI, state configuration.

In some embodiments, the TCI state configuration comprises an association to a quasi collocation, QCL, configuration associated to a non-serving cell.

In some embodiments, the QCL configuration comprises an identification of a frequency and a physical cell identity, PCI.

In some embodiments, the signal for lower layer mobility further comprises a layer 1, L1, and/or layer 2, L2, signal.

In some embodiments, the signal comprises a medium access control, MAC, control element (CE).

The receiving operation (step 1600) may include receiving a configuration of non-serving cells for L1/L2 centric inter-cell mobility. In this operation, the UE receives from the network a plurality of non-serving cell configuration(s) for at least one non-serving cell. The configuration can contain a non-serving cell reference/indication/pointer/index.

Below is an example embodiment of a non-serving cell configuration, labeled as a list of non-serving cells (“NSC”):

nsCellToAddModList SEQUENCE (SIZE (1..maxNrofNSCells)) OF NSCellConfig

| | |
|---|---|
| NSCellConfig ::= | SEQUENCE { |
| nsCellIndex | , |
| nsCellConfigCommon | ServingCellConfigCommon OPTIONAL, |
| sCellConfigDedicated | ServingCellConfig OPTIONAL, -- Cond SCellAddMod |
| nsCell-smtc | SSB-MTC OPTIONAL, -- Need S |

| | |
|---|---|
| c-RNTI | C-RNTI |

OPTIONAL -- Need R
}
[...]

In some embodiments, the ServingCellConfigCommon IE used to configure a non-serving cell for the purpose of L1/L2 inter-cell centric mobility contains the PCI of the non-serving cell (e.g., field physCellId of IE PhysCellId) and the DL frequency information of the non-serving cell (e.g., field downlinkConfigCommon of IE DownlinkConfigCommon). In some embodiments, the non-serving cell configuration can also be associated to a reference, which in the example embodiment above can be the non-serving cell index (e.g., field nsCellIndex of IE NSCellIndex, which can be an integer to be later referred in another configuration, such as in the TCI state configuration and/or within a list of TCI state configurations). The non-serving cell reference above can correspond to the field nsCellIndex of IE NSCellIndex, which can be an integer from 0 to a Max value (e.g. 8), depending on the maximum number of non-serving cells that can be configured for L1/L2 centric mobility.

An example embodiment is as follows:

-- ASN1START
-- TAG-SERVINGCELLCONFIGCOMMON-START

| ServingCellConfigCommon ::= | SEQUENCE { | |
|---|---|---|
| physCellId | PhysCellId | OPTIONAL, -- |

Cond HOAndServCellAdd,

| | |
|---|---|
| downlinkConfigCommon | OPTIONAL, -- Cond HOAndServCellAdd |

[...]

| | |
|---|---|
| ssb-PositionsInBurst | CHOICE { |
| shortBitmap | BIT STRING (SIZE (4)), |
| medium Bitmap | BIT STRING (SIZE (8)), |
| longBitmap | BIT STRING (SIZE (64)) |

} OPTIONAL, -- Cond AbsFreqSSB

| | |
|---|---|
| ssb-periodicityServingCell | ENUMERATED { ms5, ms10, ms20, ms40, ms80, ms160, |

spare2, spare1 } OPTIONAL, -- Need S
[...]

| | |
|---|---|
| ssbSubcarrierSpacing | SubcarrierSpacing OPTIONAL, -- Cond |

HOAndServCellWithSSB
[...]

| | |
|---|---|
| ssb-PositionQCL-r16 | SSB-PositionQCL-Relation-r16 OPTIONAL, -- Cond |

SharedSpectrum
[...]
}
-- TAG-SERVINGCELLCONFIGCOMMON-STOP
-- ASN1STOP

The at least one non-serving cell configuration can be organized in a set of configurations and/or a list of configurations, such as an AddMod list structure (e.g., where the same IE is used for adding and/or modifying a configuration). Some embodiments include a list for removing a non-serving cell configuration(s). The at least one non-serving cell configuration can be configured within different IEs in an RRCReconfiguration message, such as at least one of the following:

In one example embodiment, the list of non-serving cell configuration(s) is within the cell group configuration (e.g. MCG configuration) (i.e., within the IE CellGroupConfig).

| | |
|---|---|
| CellGroupConfig ::= | SEQUENCE { |
| cellGroupId | CellGroupId, |

[...]

| | | |
|---|---|---|
| spCellConfig | SpCellConfig | OPTIONAL, |

-- Need M

| | |
|---|---|
| sCellToAddModList | SEQUENCE (SIZE (1..maxNrofSCells)) OF SCellConfig |

OPTIONAL, -- Need N

| | |
|---|---|
| nsCellToAddModList | SEQUENCE |

(SIZE (1..maxNrofNSCells)) OF NSCellConfig
[...]
}

In another example embodiment, the list of non-serving cell configuration(s) is outside the cell group configuration (e.g., MCG configuration), as a way to indicate that upon L1/L2 inter-cell mobility the UE is changing SpCell, which may lead to a change in cell group. In some embodiments, there can be additional cell groups. Each SpCell associated to that cell group is a candidate for L1/L2 inter-cell mobility.

-- ASN1START
-- TAG-RRCRECONFIGURATION-START

| | |
|---|---|
| RRCReconfiguration ::= | SEQUENCE { |
| rrc-TransactionIdentifier | RRC-TransactionIdentifier, |
| critical Extensions | CHOICE { |
| rrcReconfiguration | RRCReconfiguration-IEs, |
| criticalExtensionsFuture | SEQUENCE { } |

}
}
[...]

| | |
|---|---|
| RRCReconfiguration-v17-IEs ::= | SEQUENCE { |
| masterCellGroup | OCTET STRING (CONTAINING |
| | CellGroupConfig) |

OPTIONAL, -- Need M
nsCellToAddModList SEQUENCE (SIZE (1..maxNrofNSCells)) OF NSCellConfig
[...]
}
-- TAG-RRCRECONFIGURATION-STOP
-- ASN1STOP

The at least one non-serving cell can be considered as an inter-frequency neighbour of the serving cell (as the SSBs of these cells are not in the same frequency location, e.g., the ServingCellConfigCommon of the serving cell and the ServingCellConfigCommon of the non-serving cell have different SSB's ARFCN). In some embodiments, the IE ServingCellConfigCommon can be used to configure a non-serving cell, e.g., to indicate that at least some information within the IE ServingCellConfigCommon is needed to configure a non-serving cell for L1/L2-centric inter-cell mobility. However, in some embodiments, the configuration of a non-serving cell may be defined based on a new IE (e.g., that contains information equivalent to the information in the IE ServingCellConfigCommon).

In one embodiment, the frequency information for an SSB associated to a non-serving cell in a frequency that is not a serving frequency is provided in one of a configured measurement object(s) associated to a measurement object identifier (that may later be referred in the signaling to indicate a frequency) (e.g., as provided in the MeasConfig IE). Therein some properties of these non-serving cell SSBs can be the SSB frequency information (e.g., field ssbFrequency of IE ARFCN-ValueNR), the SSB subcarrier spacing, the frequency-specific SSB measurement timing configuration (SMTC) and/or further cell specific SMTC, frequency band indicator, etc.):

| MeasObjectNR ::= SEQUENCE { | |
|---|---|
| ssbFrequency | ARFCN-ValueNR |
| OPTIONAL, -- Cond SSBorAssociatedSSB | |
| ssbSubcarrierSpacing | SubcarrierSpacing |
| OPTIONAL, -- Cond SSBorAssociatedSSB | |
| smtc1 | SSB-MTC |
| OPTIONAL, -- Cond SSBorAssociatedSSB | |
| smtc2 | SSB-MTC2 |
| OPTIONAL, -- Cond IntraFreqConnected | |
| refFreqCSI-RS | ARFCN-ValueNR |
| OPTIONAL, -- Cond CSI-RS | |
| referenceSignalConfig | , |
| [...] | |
| freqBandIndicatorNR | OPTIONAL, -- Need R |

[...]
}

In such an embodiment, the UE obtains the ServingCellConfigCommon via system information acquisition, after the L1/L2 mobility signaling is received (e.g., upon reception of the MAC CE).

In some embodiments, the receiving operation (step 1600) includes reception of at least one TCI state configuration(s) whose QCL source/configuration is associated to non-serving cell. The association between the TCI configuration (or QCL configuration) and the non-serving cell can be done by the QCL source configuration containing the non-serving cell reference (e.g., a non-serving cell index). The association can be done by the QCL source configuration containing an identification of a frequency (e.g., Measurement Object Id) and the PCI, so the UE knows that the QCL of a configured TCI state is associated to a PCI to be searched/synchronized in a frequency as indicated by the identification of a frequency and/or further frequency-specific configuration associated.

In some embodiments, there can be different solutions to associate a TCI state with a QCL source that has a reference signal (e.g., SSB and/or CSI-RS) of a non-serving cell.

In one embodiment, the QCL information configuration of a TCI state configuration contains a reference/pointer to the cell the reference signal indicated is associated with, where the reference/pointer is the PCI and ARFCN of the non-serving cell, illustrated as follows:

-- ASN1START
-- TAG-TCI-STATE-START

| | |
|---|---|
| TCI-State ::= | SEQUENCE { |
| tci-StateId | TCI-StateId, |
| qcl-Type1 | QCL-Info, |
| qcl-Type2 | QCL-Info |

OPTIONAL, -- Need R
...
}

| | |
|---|---|
| QCL-Info ::= | SEQUENCE { |
| cell | ServCellIndex |

OPTIONAL, -- Need R

| | |
|---|---|
| physCellId | PhysCellId OPTIONAL |
| downlinkConfigCommon | DownlinkConfigCommon OPTIONAL, |
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}
-- TAG-TCI-STATE-STOP
-- ASN1STOP

In another embodiment, the QCL information configuration of a TCI state configuration contains a reference/pointer to the cell the reference signal indicated is associated with, where the reference/pointer is a non-serving cell index, illustrated as follows:

-- ASN1START
-- TAG-TCI-STATE-START

| | |
|---|---|
| TCI-State ::= | SEQUENCE { |
| tci-StateId | TCI-StateId, |
| qcl-Type1 | QCL-Info, |
| qcl-Type2 | QCL-Info |

OPTIONAL, -- Need R
...
}

| | |
|---|---|
| QCL-Info ::= | SEQUENCE { |
| cell | ServCellIndex |

OPTIONAL, -- Need R

| | |
|---|---|
| nsCellIndex | NSCellIndex, |
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, type22ypedpeD}, |

...
}
-- TAG-TCI-STATE-STOP
-- ASN1STOP
// Non-serving cell configurations
nsCellToAddModList SEQUENCE (SIZE (1..maxNrofNSCells)) OF NSCellConfig

| | |
|---|---|
| NSCellConfig ::= | SEQUENCE { |
| nsCellIndex | NSCellIndex, |
| nsCellConfigCommon | ServingCellConfigCommon OPTIONAL, |

}
[...]

In another embodiment, because the QCL information of a TCI state configuration can be associated to a non-serving cell (e.g., an inter-frequency neighbour) and that multiple TCI states can be associated to the same non-serving cell, for each non-serving cell reference/pointer there can be a list of TCI states configuration(s), illustrated as follows:

| | |
|---|---|
| PDSCH-Config ::= | SEQUENCE { |

[...]
// legacy TCI state configuration for serving cell(s)

| | |
|---|---|
| tci-StatesToAddModList | SEQUENCE (SIZE(1..maxNrofTCI-States)) OF TCI-State |

OPTIONAL, -- Need N
[...]
// TCI state configuration for non-serving cell(s)

| | |
|---|---|
| tci-StatesToAddModList-NSC | SEQUENCE (SIZE(1..maxNrof-NSC)) OF TCI-State- |

NSC OPTIONAL,

| | |
|---|---|
| TCI-State-NSC ::= | SEQUENCE { |
| nsCellIndex | NSCellIndex, |
| tci-StatesToAddModList | SEQUENCE (SIZE(1..maxNrofTCI-States)) OF TCI-State |

}
}

Hence, any TCI state has within it, as a QCL source, a reference signal associated to the non-serving cell associated to that index (e.g., nsCellIndex). In an example embodiment, assuming 4 TCI states are associated to 2 non-serving cells (e.g., TCI=1 and TCI=2 with non-serving cell A whose non-serving cell index=7, and TCI=3 and TCI=4 with non-serving cell B, whose non-serving cell index=13). In this embodiment, the PDSCH configuration (or, e.g., any other IE containing TCI state configuration(s)) can contain within tci-StatesToAddModList-NSC the following:
TCI-State-NSC(1), for non-serving cell A;
   nsCellIndex=7
   TCI=1 and TCI=2 with reference signals in QCL source associated to cell A, indexed by nsCellIndex=7;
TCI-State-NSC(2), for non-serving cell B;
   nsCellIndex=13
   TCI=3 and TCI=4 with reference signals in QCL source associated to non-serving cell B, indexed by nsCellIndex=13

Accordingly, DL signaling can be saved in the sense that multiple TCI states have QCL source reference signals associated to the same non-serving cell, which may be a common scenario. Since more TCI states are associated to the same non-serving cell (e.g., QCL reference signal associated to that non-serving cell), the more relevant the signaling optimization may be compared to the previous case where the non-serving cell reference can be repeated for every TCI state configuration/QCL info configuration.

In another embodiment, because the QCL information of a TCI state configuration can be associated to a non-serving cell (e.g., an inter-frequency neighbour) and that multiple TCI states can be associated to the same non-serving cell, for each non-serving cell reference/pointer there can be a list of TCI states configuration(s), where the reference/point is the PCI and the ARFCN, illustrated as follows:

| | |
|---|---|
| PDSCH-Config ::= | SEQUENCE { |

[...]
// legacy TCI state configuration for serving cell(s)

| | |
|---|---|
| tci-StatesToAddModList | SEQUENCE (SIZE(1..maxNrofTCI-States)) OF TCI-State |

OPTIONAL, -- Need N
[...]
// TCI state configuration for non-serving cell(s)

| | |
|---|---|
| tci-StatesToAddModList-NSC | SEQUENCE (SIZE(1..maxNrof-NSC)) OF TCI-State- |

NSC OPTIONAL,

| TCI-State-NSC ::= | SEQUENCE { | |
|---|---|---|
| physCellId | PhysCellId | OPTIONAL |

| | |
|---|---|
| downlinkConfigCommon | DownlinkConfigCommon OPTIONAL, |
| tci-StatesToAddModList | SEQUENCE (SIZE(1..maxNrofTCI-States)) OF TCI-State |

}
}

Hence, any TCI state has within it, as QCL source, a reference signal associated to the non-serving cell associated to the non-serving cell PCI and the non-serving cell DL frequency information configuration (e.g., that contains the SSB ARFCN). In an example embodiment, 4 TCI states are associated to 2 non-serving cells (e.g., TCI=1 and TCI=2 with non-serving cell A whose non-serving cell PCI=5 and ARFCN=X, and TCI=3 and TCI=4 with non-serving cell B, whose non-serving cell PCI=13 and ARFCN=Y). In this embodiment, the PDSCH configuration (or, e.g., any other IE containing TCI state configuration(s)) can contain within tci-StatesToAddModList-NSC the following:
TCI-State-NSC(1), for non-serving cell A;
   PCI=5 and ARFCN=X;
   TCI=1 and TCI=2 with reference signals in QCL source associated to cell A;
TCI-State-NSC(2), for non-serving cell B;
   PCI=13 and ARFCN=Y;
   TCI=3 and TCI=4 with reference signals in QCL source associated to non-serving cell B;

An estimate of the signaling gain, without the structure above, that would have been received by the UE would have been twice as long, as illustrated in the following:
TCI-State-NSC(1), for non-serving cell A;
   PCI=5 and ARFCN=X;
   TCI=1 with reference signals in QCL source associated to cell A;
TCI-State-NSC(2), for non-serving cell A;
   PCI=5 and ARFCN=X;
   TCI=2 with reference signals in QCL source associated to cell A;
TCI-State-NSC(3), for non-serving cell B;
   PCI=13 and ARFCN=Y;
   TCI=3 with reference signals in QCL source associated to non-serving cell B;
TCI-State-NSC(4), for non-serving cell B;
   PCI=13 and ARFCN=Y;
   TCI=4 with reference signals in QCL source associated to non-serving cell B.

The following example embodiment illustrates how the information can be structured in a non-optimized case: RRCReconfiguration
Configuration of a plurality of non-serving cells
Each non-serving cell configuration contains
   A configuration reference, e.g., non-serving cell index
   Non-serving cell specific configuration, e.g., as in ServingCellConfigCommon
   Configuration of SSB properties, e.g., SMTC
TCI state configuration
   QC information
      Reference signal configuration, e.g. SSB index Reference to non-serving cell where the SS properties for that SSB index is to be found

In another example embodiment, the information can be structured as follows: RRCReconfiguration
Configuration of a plurality of non-serving cells
   Non-serving cell configuration (1), non-serving cell index=1
   Non-serving cell configuration (2), non-serving cell index=2
   . . .
AddMod list of TCI state configuration(s)
   QCL information
      Reference signal configuration, e.g. SSB index
         Reference to non-serving cell where the SS properties for that SSB index is to be found, e.g. non-serving cell index=k

Further embodiments are provided herein that include enhancements to the configurations, e.g. inclusion of a TAG identifier in the non-serving cell configuration (e.g., within the IE ServingCellConfigCommon).

Still referring to FIG. 16, the method includes handling of TA for non-serving cells. The method includes determining (step 1602), based in the received information (e.g., the indication of a new TCI state (e.g., indicated by a received MAC CE)) from the network node, whether the TA is valid or not for the at least one non-serving cell associated with the indicated TCI state.

In some embodiments, this determination is needed before the UE is able to properly perform UL transmissions in the target cell after the L1/L2 centric inter-cell mobility, otherwise interference can be generated.

The determining operation (step 1602) can include at least one of the following operations:

Determining that the TA is valid or not, for the non-serving cell associated with the indicated TCI state, upon receiving the indication of a new TCI state (e.g., indicated by a received MAC CE).

In one embodiment, the determination (step 1602) of the validity of the TA is done by configuration, e.g., as part of the non-serving cell configuration and/or the TCI state configuration.

In some embodiments, the determining (step 1602) comprises that the TA is invalid when the indicated TCI state has a QCL configuration associated to a non-serving cell.

In some embodiments, determining (step 1602) if the TA is valid or invalid is based on a configuration comprising a TA validity indication.

In some embodiments, the configuration comprises an indication that the TA is always valid.

In some embodiments, determining (step 1602) if the TA is valid or invalid is based on a timer.

In some embodiments, the timer is a time alignment timer.

In some embodiments, determining (step 1602) if the TA is valid or invalid based on a timer comprises determining that the TA is valid when the timer is running and determining that the TA is invalid when the timer is not running.

In some embodiments, when the timer for time alignment is running, the timer for time alignment is associated to a non-serving cell associated with the indicated transmission configuration.

In some embodiments, the timer is a time alignment group, TAG, timer associated to a target non-serving cell.

In some embodiments, the TAG comprises a serving cell and a non-serving cell.

In some embodiments, determining (step 1602) if the TA is valid or invalid is based on a timer comprises determining that the TA is valid when the TAG timer is running for the TAG and determining that the TA is invalid when the TAG timer is not running for the TAG.

In some embodiments, determining (step 1602) if the TA is valid or invalid is based on a timing difference of downlink, DL, reference signals in an old (i.e., current) transmission configuration, TCI, state and a new TCI state (i.e., the indicated TCI state configuration). For example, if the timing difference is larger than a certain threshold, the TA would be considered invalid.

In some embodiments, the old TCI state is associated with a CORESET pool index x, and wherein determining if the TA is valid or invalid comprises determining that the TA is valid when the new TCI state has a PCI that is the same as the PCI of the old TCI state.

In some embodiments, determining (step 1602) if the TA is valid or invalid comprises determining that TA is invalid when the new TCI state has a first PCI that is different than a second PCI of the old TCI state.

In another embodiment, where the source and the target are unsynchronized, the configuration indicates that the TA is always invalid.

In some embodiments, the reception of a L1/L2 signaling for L1/L2 centric inter-cell mobility to a non-serving cell (e.g., MAC indicating a TCI whose QCL source is associated to a non-serving cell, such as an SSB from a non-serving cell) triggers the UE to perform a random access to the indicated non-serving cell (that is, the target cell in the procedure). The indicated non-serving cell is the non-serving cell associated to the indicated TCI state (e.g., whose TCI state ID is included in the MAC CE for L1/L2 centric inter-cell mobility). In this embodiment, the UE determines (step 1602) that the TA is not valid by determining that the indicated TCI state has a QCL configuration associated to a non-serving cell (e.g., a non-serving cell cannot belong to a TAG configured at the UE). Hence, upon determining this is a non-serving cell, the UE determines that the TA is not valid. Hence, the UE performs SSB measurements, if not available or if the UE wants to update these measurements on L1, (such as SS-RSRP measurement). The UE further performs random access resource selection (e.g., if SS-RSRP is above a configured SSB RSRP threshold) and selects a PRACH resource (associated to the selected SSB), to then transmit a RACH preamble, and receive a random access response including the TA command (upon which the UE can apply the TA to be considered for the indicated cell).

In some embodiments, for a TA group for non-serving cells used for L1/L2 centric mobility, the determination (step 1602) relies on the assistance of a group information. In one embodiment, the UE receives one or a plurality of non-serving cell configuration(s), wherein a non-serving cell configuration (e.g., configuration of IE ServingCellConfigCommon) includes an indication of a group the non-serving cell belongs to, and wherein the group represents a set of cells associated with the same TA. In another embodiment, the indication is a TAG identifier (e.g., field tag-Id of IE TAG-Id as defined in TS 38.331 V16.3.0, but according to the method extended to non-serving cell(s), in particular to non-serving cells wherein the UE can perform L1/L2 centric inter-cell mobility). The indication may be included in the non-serving cell configuration within, or together with, the NonServingCellConfig and/or NonServingCellConfigCommon (e.g., for the non-serving cell, and with some similar content as the IE ServingCellConfigCommon). The TAG identifier may refer to a TAG configuration configured in the CellGroupConfig associated to the serving cell (e.g., SpCell) the UE has been configured with the TCI state configuration(s).

In some embodiments, if the UE is connected to cell-A and receives a L1/L2 signaling with a TCI state indication (e.g., MAC CE, for inter-cell mobility) for a TCI state ID whose QCL source is associated to cell-B, and the serving cell-A and the non-serving cell-B have the same TAG Id indicated in their RRC configuration, the UE can assume the same time alignment is applicable for both cells and actions are performed based on that assumption. For example, the UE does not perform random access towards the cell-B when it receives the L1/L2 signaling with a TCI state indication (e.g., MAC CE for inter-cell mobility). Further actions may also be performed, e.g., timer of time alignment keeps running, etc.

In some embodiments, if the UE is connected to cell-A and receives a L1/L2 signaling with a TCI state indication (e.g., MAC CE, for inter-cell mobility) for a TCI state ID whose QCL source is associated to cell-B, and the serving cell-A and the non-serving cell-B have different TAG Id(s) indicated in their RRC configuration, the UE does not assume the same time alignment is applicable for both cells and actions are performed based on that. In an example embodiment, an action that the UE performs is random access towards the cell-B when it receives the L1/L2 signaling with a TCI state indication (e.g., MAC CE, for inter-cell mobility), so that it receives a new time alignment information for cell-B in a random access response. Further actions may also be performed, e.g., reset of the time alignment timer, etc.

Example embodiments are discussed below of how the UE can be configured with a non-serving cell configuration that includes an indication of the TAG group the non-serving cell belongs to.

In an example embodiment, non-serving cells for L1/L2 centric inter-cell mobility are configured as a list of IE(s) (e.g., NSCellConfig, for example, within an RRC Reconfiguration message, possibly as part of the Cell Group Configuration (IE CellGroupConfig)). Then, within each non-serving cell configuration there can be a group identity for the time alignment (e.g., field tag-Id of IE TAG-Id), indicating that non-serving cells belonging to that group can rely on the same TA advance command and/or can be considered to be time aligned.

nsCellToAddModList SEQUENCE (SIZE (1..maxNrofNSCells)) OF NSCellConfig

| | |
|---|---|
| NSCellConfig ::= | SEQUENCE { |
| nsCellIndex | NSCellIndex, |
| nsCellConfigCommon | ServingCellConfigCommon OPTIONAL, |
| tag-Id | TAG-Id, |

[...]
}

[...]
tag-Id
TAG ID which this non-serving cell belongs to.

Tag ID refers to a TAG that has also been configured, e.g., a TAG-Config within the Cell Group Configuration, as shown below. As explained herein, multiple non-serving cells can be associated to the same TAG ID to indicate that they belong to the same group. Thus, if a time alignment timer is running for the group, the UE can perform L1/L2 centric inter-cell mobility across the cells within that group without the need to update the TA.

TAG-Config IE
-- ASN1START
-- TAG-TAG-CONFIG-START

| | |
|---|---|
| TAG-Config ::= | SEQUENCE { |

[...]

| | |
|---|---|
| tag-ToAddModList | SEQUENCE (SIZE (1..maxNrofTAGs)) OF TAG |

OPTIONAL -- Need N
}

| | |
|---|---|
| TAG ::= | SEQUENCE { |
| tag-Id | TAG-Id, |
| timeAlignmentTimer | TimeAlignmentTimer, |

...
}

| | |
|---|---|
| TAG-Id ::= | INTEGER (0..maxNrofTAGs-1) |

TimeAlignmentTimer ::= ENUMERATED {ms500, ms750, ms1280, ms1920, ms2560,
ms5120, ms10240, infinity}
-- TAG-TAG-CONFIG-STOP
-- ASN1STOP

In some embodiments, a TA group comprises serving cells and non-serving cells, i.e., at least one serving cell and one non-serving cell can be associated to the same group.

In some embodiments, the TA group is separated for serving cells and non-serving cells, i.e., there are TA groups for serving cells and TA groups for non-serving cells, wherein the non-serving cells refer to the non-serving cells initially configured as they can become a serving cell upon the reception of the L1/L2 centric inter-cell mobility command e.g. MAC CE.

In some embodiments, the TA group is separated per frequency wherein only intra-frequency cells can be part of the same TA group. In some other embodiments, the TA group belongs to a serving cell on one frequency and non-serving cells on another frequency. In yet other embodiments, a TA group can include a list of serving cells, each being on different frequency and a list of non-serving cells on one or more frequencies. In one embodiment, any PDCCH ordered RA received in conjunction with the TCI state change associated to serving cell change is used as an implicit indication to perform the RA on the non-serving cell after the L1/L2 centric mobility. In some embodiments, the PDCCH ordered RA and the TCI state change related MAC CE need not be received at the time slot. However, if the PDCCH ordered RA request is received, and if the UE receives the MAC CE including the TCI state change associated to a non-serving cell and if the next available RA resource is at a time slot which is after the reception of the MAC CE including the TCI state change associated to a non-serving cell, then the UE considers this as an implicit indication to perform RA after the L1/L2 mobility switching to the non-serving cell.

Referring again to FIG. 16, the method includes further optional operations. If the UE determines that TA is not valid for the at least one associated non-serving cell, the UE performs (step 1604) a procedure to obtain the TA for the at least one associated non-serving cell.

In some embodiments, in response to determining that the TA is invalid, a procedure is performed (step 1604) to obtain the TA for at least one non-serving cell associated with the indicated transmission configuration.

In some embodiments, the procedure to obtain the TA for the associated non-serving cell is a random access procedure (e.g. as defined in TS 38.321 V16.2.1 for NR).

In some embodiments, the procedure is at least one of a random access procedure, and a reception of a TA command in a target cell after a L1 and/or L2 mobility procedure.

In some embodiments, the UE does not trigger a random access to the non-serving cell upon reception of the L1/L2 centric inter-cell mobility, such as the MAC CE, but first it waits until there is a need for UL transmission in the non-serving cell. FIG. 10 is a signaling diagram illustrating such an example embodiment.

In some embodiments, the UE stops the time alignment timer, and perform actions upon the stopping of the time alignment timer.

In some embodiments, the procedure comprises a set of actions, including at least one of the following actions:
flush all Hybrid automatic repeat request (hybrid ARQ or HARQ) buffers for all Serving Cells; which can correspond to the HARQ buffers for the cell group. For example, changing the SpCell via L1/L2 centric inter-cell mobility can be considered as changing the cell group,
flush all HARQ buffers for the SpCell (e.g., PCell or PScell) that is being switched, i.e. for the source SpCell;
notify a RRC layer/entity to release PUCCH for all Serving Cells, if configured;
notify RRC to release PUCCH for the SpCell, i.e. the source cell;
notify RRC to release sounding reference signal (SRS) for all Serving Cells, if configured;
notify RRC to release SRS for the SpCell, if configured;
clear any configured DL assignments and configured UL grants;
clear any PUSCH resource for semi-persistent CSI reporting;
consider all running timeAlignmentTimers as expired;
maintain NTA (defined in TS 38.211 V16.3.0) of all TAGs;
etc.

In some embodiments, the procedure is the reception of a TA command (e.g., MAC CE from the indicated non-serving cell) in the target cell (e.g., the indicated non-serving cell) after the L1/L2 mobility procedure (i.e., after processing the MAC CE from the serving cell (e.g., cell-A in FIG. 11), not necessarily as part of a random access procedure. In that case, the target cell (which used to be a non-serving cell configured for L1/L2 centric inter-cell mobility) may be able to calculate the TA for that UE e.g. based on the detection of SRS transmissions and/or other UL transmissions (preambles) from that UE and/or a knowledge about timing differences between source and target cells. The TA command may comprise a TA value, for example, for the UE to use/to apply.

In some embodiments, the UE transmits configured SRS(s) (e.g., configured for that purpose and transmitted by the UE, e.g., to that target cell) upon the reception of the L1/L2 signaling for L1/L2 centric inter-cell mobility. In another embodiment, the SRS transmission with that configuration starts when the DL quality (e.g., SS-RSRP) of the non-serving cell is above a certain threshold (e.g., a configurable threshold), meaning that the non-serving cell can be a potential candidate for L1/L2 centric inter-cell mobility. In some embodiments, the UE can do so for non-serving cells for which there are associated SRS configured and for which the threshold criteria (or other criteria (e.g., criteria associated to an A3, A5, A4 event as defined in TS 38.331 V16.3.0, such as when a non-serving cell/neighbour cell is an offset better than the serving cell for a given quantity, like RSRP, RSRQ and/or SINR)).

Still referring to FIG. 16, in some embodiments, the determination (step 1602) is done by determining whether a time alignment timer is running. If the timer is running the UE considers the TA as valid; if the timer is not running, the UE considers the TA as not valid. FIG. 11 is a signaling diagram illustrating such an example embodiment.

In some embodiments, the determination (step 1602) is done by determining whether a time alignment timer is running, wherein the time alignment timer is associated to the non-serving cell. If the time alignment timer is running for the non-serving cell, the UE considers the TA for the non-serving cell as valid. If the time alignment timer for the non-serving cell is not running, the UE considers the TA for the non-serving cell as not valid. In an example embodiment, the MAC entity used in the serving cell does not remain the same as the MAC entity in the target cell (e.g., the indicated non-serving cell), as different cell groups have different MAC entities.

In some embodiments, the determination (step 1602) is done by determining whether the time alignment timer, associated to a TAG associated to the indicated non-serving cell is running. If the timer is running, the UE considers the TA for the indicated non-serving cell as valid. If the timer is not running, the UE considers the TA for the indicated non-serving cell as not valid.

Such embodiments can include a TAG including serving cell and non-serving cells. For example, if the UE is connected to a serving cell A, e.g., the PCell, the serving cell A belongs to a TAG whose TAG identity=2; and a non-serving cell B also belongs to that TAG whose TAG identity=2 (e.g., indicated as part of the non-serving cell configuration for L1/L2 centric inter-cell mobility). If the UE receives a switching command indicating a new TCI whose QCL source is associated to cell-B, the UE determines that cell-B belongs to the same TAG as cell-A; and, if the time alignment timer is running for that group, the UE considers the current TA for that TAG as valid. Otherwise, if the timer is not running for that group, the UE considers the TA for that group (and, consequently for the non-serving cell) as not valid.

In another embodiment, if the UE is connected to a serving cell A, e.g., the PCell, the serving cell A belongs to a TAG whose TAG identity=2; and a non-serving cell B also belongs to that TAG whose TAG identity=1 (e.g., indicated as part of the non-serving cell configuration for L1/L2 centric inter-cell mobility). If the UE receives a switching command indicating a new TCI whose QCL source is associated to cell-B, the UE determines that cell-B belongs to a different TAG as cell-A. If the time alignment timer is not running for the non-serving cell group, the UE considers the TA for the TAG of the non-serving cell as not valid.

Still referring to FIG. 16, in some embodiments, if the UE determines that TA is valid for the at least one associated non-serving cell, the UE does not perform (step 1606) a procedure to obtain the TA for the associated non-serving cell.

In some embodiments, in response to determining that the TA is valid, performance of a procedure is omitted (step 1606) to obtain the TA for an associated non-serving cell.

In some embodiments, the UE determines that the TA is valid for the associated non-serving cell if the time alignment timer is running for that non-serving cell and/or for a group associated to the non-serving cell.

The UE may determine that the TA is valid if the UE has previously established a TA for that non-serving cell and/or for the TA group (e.g., it has previously performed random access to that cell and/or previously received a TA command). If the TA is valid, there is no interruption in the UL communication, which may improve the quality of service.

In some embodiments, when the TA is valid, the TA is valid for a MAC entity before and after an L1 and/or L2 inter-cell mobility.

Now embodiments allowing the UE to obtain (e.g., before the UE needs to perform L1/L2 centric inter-cell mobility to the non-serving cell) and maintain TA of the non-serving cells configured for L1/L2 centric inter-cell mobility will be described. They may avoid the need for the UE to perform further actions for the TA update upon L1/L2 centric inter-cell mobility.

As mentioned earlier, the UE can receive a TA command for a non-serving cell (and/or for a TAG including a non-serving cell) from a serving cell.

The serving cell can be the PCell the UE is connected to when it receives the L1/L2 signaling/command for L1/L2 centric inter-cell mobility.

The TA command for the non-serving cell can be received multiplexed (e.g., in a MAC level) with the L1/L2 signaling/command for L1/L2 centric inter-cell mobility. The TA command includes an indication enabling the UE to identify that it refers to the non-serving cell (e.g., no-serving cell index and/or TAG Id associated to the non-serving cell (i.e., the non-serving cell belongs to)).

In an embodiment, the TA command for the non-serving cell (or information associated to it) is received within the L1/L2 signaling/command for L1/L2 centric inter-cell mobility, which also includes an indication enabling the UE to identify that it refers to the non-serving cell (e.g., no-serving cell index and/or TAG Id associated to the non-serving cell)).

In such an embodiment, the SRS transmission with that configuration starts when the DL quality (e.g., SS-RSRP) of the non-serving cell is above a certain threshold (e.g., a configurable threshold), meaning that the non-serving cell can be a potential candidate for L1/L2 centric inter-cell mobility. In some embodiments, the UE can do so for non-serving cells for which there are associated SRS configured and for which the threshold criteria (or other criteria, such as criteria associated to an A3, A5, A4 event as defined in TS 38.331 V16.3.0 (e.g., when a non-serving cell/neighbour cell is an offset better than the serving cell for a given quantity, like RSRP, RSRQ and/or SINR)).

In some embodiments, the UE obtains a TA for a non-serving cell configured for L1/L2 centric inter-cell mobility upon the reception of the message configuring the non-serving cell (e.g., an RRC Reconfiguration message). This can be triggered by a random access towards the non-serving cell.

In the some example embodiments, the random access preamble is transmitted and the UE receives a TA command. Another embodiment is a contention based random access procedure and the UE transmits a preamble and receives a RAR including the TA command. Then, the UE sends a message (e.g., msg3 including its assigned cell-radio network temporary identifier (C-RNTI)) to indicate the UE is not requesting the access to that cell but is requesting the TA command.

Referring again to FIG. 16, in some embodiments, upon receiving a TA command from the network for the non-serving cell configured for L1/L2 centric inter-cell mobility, the UE starts the time alignment timer. If the timer expires, the UE considers the TA is not valid for that cell. If the timer expires, in some embodiments, the UE triggers a random access procedure with the non-serving cell for which the timer has expired.

In some embodiments, a non-serving cell is defined as a group representative (i.e., a cell associated to the group) wherein the UE performs random access when the time alignment timer for that group has expired. After the UE receives the TA command, the UE assumes it is valid for the whole group.

Still referring to FIG. 16, in some embodiments, the UE obtains the TA for at least one non-serving cell when the non-serving cell is being configured for L1/L2-centric inter-cell mobility, for example, upon reception of an RRC Reconfiguration including at least one TCI state configuration whose QCL source is associated to a non-serving cell.

In some embodiments, the UE obtains a TA for a non-serving cell configured for L1/L2 centric inter-cell mobility after the reception of the message configuring the non-serving cell (e.g., an RRC Reconfiguration message). In some embodiments, the UE obtains a TA for a non-serving cell configured for L1/L2 centric inter-cell mobility after the reception of the message configuring the non-serving cell where data is not being transmitted/received: in a serving cell, during a measurement gap, during an autonomous gap, and/or during a discontinuous reception (DRX) period, etc.

In some embodiments, upon being configured with one or multiple non-serving cells, the UE obtains time information for the non-serving cells. In one embodiment, the UE triggers random access for the non-serving cells and receives the TA command via the RAR. In another embodiment, the UE performs random access only for one cell per TAG (and assumes the obtained TA is valid for other non-serving cells in the same group).

In some embodiments, the UE receives an indication in the L1/L2 signaling for L1/L2 centric inter-cell mobility that it shall perform random access to the target cell associated to the QCL source of the indicated TCI state (e.g., UE stops time alignment timer). The absence of that indication is an indication that the UE does not need to perform random access and that it may assume as valid its current TA (i.e., upon that the time alignment timer continues to run).

Various embodiments of the present disclosure include handling of TA for multiple TRPs associated with different CORESET pool indices.

In some embodiments, to handle multiple TAs for multiple TRPs, different TAs are associated with each CORESET pool index where each CORESET pool index represents a TRP. Furthermore, in some embodiments, different time alignment timers may be configured for each CORESET pool index.

In some embodiments, as a UE can be configured with two different CORESET pool indices in a serving cell, the existing TA command MAC CE in FIG. 6.1.3.4-1 of 3GPP TS 38.300 V16.3.0 (discussed herein) may not be suitable as it does not provide which CORESET pool index the TA command should be applied to. In one embodiment, a CORESET pool index that the TA command should be applied to may be determined implicitly at the UE. If the TA command MAC CE is received (step 1600) via a CORESET with CORESET pool index x (e.g., x=0 or 1), then the TA command is applied to the TA associated with CORESET pool index x. In this embodiment, the timing alignment timer associated with CORESET pool index x is reset if the UE receives an updated timing command in a CORESET with CORESET pool index x. A UE is no longer UL synchronized to a TRP associated with CORESET pool index x if the UE does not receive an updated timing command in a CORESET with CORESET Pool index x before the associated TA timer expires.

In some embodiments, when an indication of a new TCI state associated with a non-serving cell is received (step 1600) via a CORESET with CORESET pool index x (e.g., the indication may be via MAC CE), whether the TA associated with CORESET pool index x is valid or not is determined via configuration. In some embodiments, a configuration such as a PCI in the newly indicated TCI state may indicate the validity of the TA. If the newly indicated TCI state has the same PCI as the current TCI state associated with CORESET pool index x, then the TA can be considered valid. In some embodiments, if the newly indicated TCI state contains a different PCI compared to the current TCI state associated with CORESET pool index x, then the TA is considered invalid. In place of PCI, other parameters associated with a CORESET pool index may also be used to indicate validity of the TA associated with that CORESET pool.

In some embodiments, when an indication of a new TCI state associated with a non-serving cell is received (step 1600) via a CORESET with CORESET pool index x (e.g., receiving a MAC CE indicating a new TCI state whose QCL source is associated to a non-serving cell, such as an SSB from a non-serving cell), then the UE performs a random access to the TRP corresponding to the CORESET pool index x. In this embodiment, the UE determines (step 1602) that the TA associated with CORESET pool index x is not valid by determining that the indicated new TCI state has a QCL source configuration associated to a non-serving cell.

Although a CORESET pool index is used in the above example embodiments, another configuration parameter may be used in place of a CORESET pool index to identify a TRP. For example, as referenced in an example embodiment below, the SSB_Id may be used. Furthermore, an SSB_Id may be used instead of a PCI in embodiments of the present disclosure.

In some embodiments, additional SSBs (e.g., “added SSB(PCI)” which are identified by an ID), referred to herein as a SSB_Id, can be grouped such that one grouping belongs to one time alignment group independent of whether the added SSB(s) is/are associated to a separate serving cell or not. As a consequence, time alignment can be different within a serving cell configuration in embodiments including an additional SSB(s).

In some embodiments, the lower layer mobility comprises an L1/L2 based inter-cell mobility.

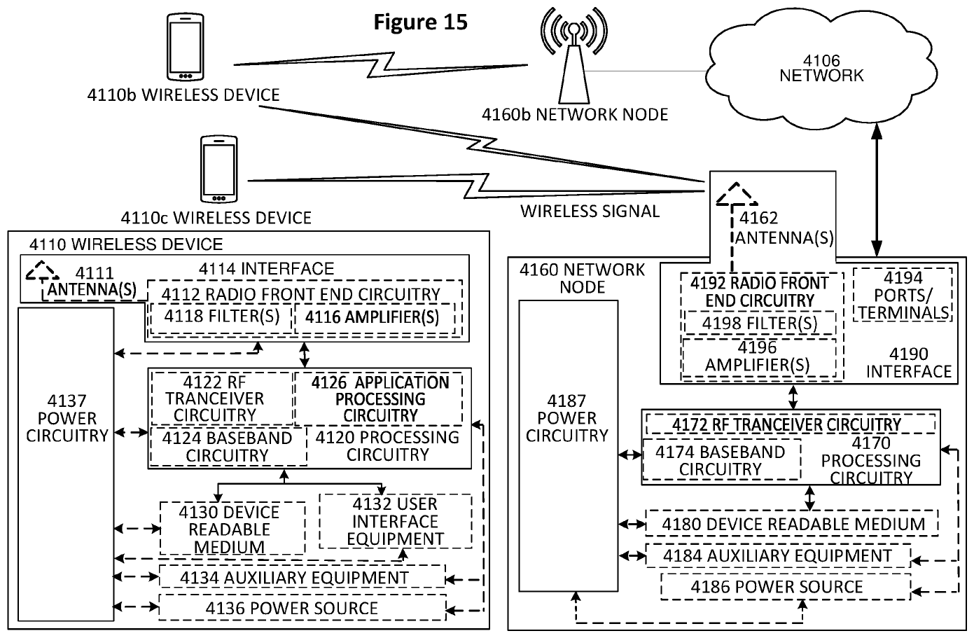

Operations of the flowchart of FIG. 16 are performed by a communication device 601. The communication device 601 can be implemented using the structures of the block diagram of communication device 4110 of FIG. 15 (discussed further herein). For example, modules may be stored in memory 4130 of communication device 4110 of FIG. 15. These modules may provide instructions so that when the instructions of a module are executed by respective computer processing circuitry 4120, the processing circuitry performs respective operations of the flow chart.

Each of the operations described in FIG. 16 can be combined and/or omitted in any combination with each other, and it is contemplated that all such combinations fall within the spirit and scope of this disclosure.

Various operations from the flow chart of FIG. 16 may be optional with respect to some embodiments. For example, operations of blocks 1604 and 1606 of FIG. 16 may be optional.

While some embodiments discussed herein are explained in the non-limiting context of L1/L2 centric inter-cell mobility, the present disclosure is not so limited. Instead, the method of the present disclosure includes, without limitation, other multi-cell multi TRP solutions in the sense that when a TRP is added (e.g., configured via RRC), the UE may need to establish UL synchronization with the TRP(s) (e.g., as fast as possible) that may be later dynamically activated/deactivated for UL transmissions. If these TRPs are associated to non-serving cells, similar issues related to UL synchronization may exist so that an early acquisition of TA for non-serving cells also may be beneficial.

FIG. 15 is a schematic overview of a wireless network (e.g., a communication network), including a communication device 4110 and a network node 4160, in accordance with some embodiments. The communication device 4110 is configured according to some embodiments. The communication device 4110 can include, without limitation, a UE, a wireless terminal, a wireless communication device, a wireless communication terminal, a terminal node/device, etc. The communication device 4110 includes a transceiver 4122 comprising one or more power amplifiers 4116 that transmit and receive through antennas of an antenna or antenna array 4111 to provide UL and DL radio communications with a radio network node (e.g., network node 4160, a base station, eNB, gNB, a ng-eNB, etc.) of a telecommunications network. Communication device 4110 further includes a processor circuit 4120 (also referred to as a processor or processing circuitry) coupled to the transceiver 4122 and a memory circuit 4130 (also referred to as memory). The memory 4130 stores computer readable program code that when executed by the processor 4120 causes the processor 4120 to perform operations of FIG. 16.

Although the subject matter described herein may be implemented in any appropriate type of system using any suitable components, the embodiments disclosed herein are described in relation to a wireless network, such as the example wireless network illustrated in FIG. 15. For simplicity, the wireless network of FIG. 15 only depicts network 4106, network node 4160, and WDs 4110. In practice, a wireless network may further include any additional elements suitable to support communication between communication devices or between a communication device and another communication device, such as a landline telephone, a service provider, or any other network node or end device. Of the illustrated components, network node 4160 and communication device 4110 are depicted with additional detail. The wireless network may provide communication and other types of services to one or more communication devices to facilitate the communication devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), LTE, and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network node 4160 comprises various components described in more detail below. These components work together in order to provide network node and/or communication device functionality, such as providing wireless connections in a wireless network. In different embodiments, the wireless network may comprise any number of wired or wireless networks, network nodes, base stations, controllers, communication devices, relay stations, and/or any other components or systems that may facilitate or participate in the communication of data and/or signals whether via wired or wireless connections.

The network node 4160 includes a processor circuit 4170 (also referred to as a processor or processing circuitry), a memory circuit 4180 (also referred to as memory), and a network interface 4190 (e.g., wired network interface and/or wireless network interface) configured to communicate with other network nodes. The network node 4160 may be configured as a radio network node containing a transceiver 4172 with one or more power amplifiers that transmit and receive. The memory 4180 stores computer readable program code that when executed by the processor 4170 causes the processor 4170 to perform operations according to embodiments disclosed herein.

As used herein, network node refers to equipment capable, configured, arranged and/or operable to communicate directly or indirectly with a communication device and/or with other network nodes or equipment in the wireless network to enable and/or provide wireless access to the communication device and/or to perform other functions (e.g., administration) in the wireless network. Examples of network nodes include, but are not limited to, radio access nodes (RANs), access points (APs) (e.g., radio access points), base stations (BSs) (e.g., radio base stations, Node Bs, eNBs and gNBs).

In FIG. 15, network node 4160 includes processing circuitry 4170, device readable medium 4180, interface 4190, auxiliary equipment 4184, power source 4186, power circuitry 4187, and antenna 4162. It is to be understood that a network node comprises any suitable combination of hardware and/or software needed to perform the tasks, features, functions and methods disclosed herein. Moreover, while the components of network node 4160 are depicted as single boxes located within a larger box, or nested within multiple boxes, in practice, a network node may comprise multiple different physical components that make up a single illustrated component (e.g., device readable medium 4180 may comprise multiple separate hard drives as well as multiple RAM modules).

Processing circuitry 4170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 4160 components, such as device readable medium 4180, network node 4160 functionality. For example, processing circuitry 4170 may execute instructions stored in device readable medium 4180 or in memory within processing circuitry 4170. Such functionality may include providing any of the various wireless features, functions, or benefits discussed herein. In some embodiments, processing circuitry 4170 may include a system on a chip (SOC).

In some embodiments, processing circuitry 4170 may include one or more of radio frequency (RF) transceiver circuitry 4172 and baseband processing circuitry 4174. In some embodiments, radio frequency (RF) transceiver circuitry 4172 and baseband processing circuitry 4174 may be on separate chips (or sets of chips), boards, or units, such as radio units and digital units. In alternative embodiments, part or all of RF transceiver circuitry 4172 and baseband processing circuitry 4174 may be on the same chip or set of chips, boards, or units.

Device readable medium 4180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 4170. Device readable medium 4180 may store any suitable instructions, data or information, including a computer program, software, an application including one or more of logic, rules, code, tables, etc. and/or other instructions capable of being executed by processing circuitry 4170 and, utilized by network node 4160. Device readable medium 4180 may be used to store any calculations made by processing circuitry 4170 and/or any data received via interface 4190. In some embodiments, processing circuitry 4170 and device readable medium 4180 may be considered to be integrated.

Interface 4190 is used in the wired or wireless communication of signalling and/or data between network node 4160, network 4106, and/or WDs 4110. As illustrated, interface 4190 comprises port(s)/terminal(s) 4194 to send and receive data, for example to and from network 4106 over a wired connection. Interface 4190 also includes radio front end circuitry 4192 that may be coupled to, or in certain embodiments a part of, antenna 4162. Radio front end circuitry 4192 comprises filters 4198 and amplifiers 4196. Radio front end circuitry 4192 may be connected to antenna 4162 and processing circuitry 4170. Radio front end circuitry may be configured to condition signals communicated between antenna 4162 and processing circuitry 4170. Radio front end circuitry 4192 may receive digital data that is to be sent out to other network nodes or WDs via a wireless connection. Radio front end circuitry 4192 may convert the digital data into a radio signal having the appropriate channel and bandwidth parameters using a combination of filters 4198 and/or amplifiers 4196. The radio signal may then be transmitted via antenna 4162. Similarly, when receiving data, antenna 4162 may collect radio signals which are then converted into digital data by radio front end circuitry 4192. The digital data may be passed to processing circuitry 4170. In other embodiments, the interface may comprise different components and/or different combinations of components.

In certain alternative embodiments, network node 4160 may not include separate radio front end circuitry 4192, instead, processing circuitry 4170 may comprise radio front end circuitry and may be connected to antenna 4162 without separate radio front end circuitry 4192. Similarly, in some embodiments, all or some of RF transceiver circuitry 4172 may be considered a part of interface 4190. In still other embodiments, interface 4190 may include one or more ports or terminals 4194, radio front end circuitry 4192, and RF transceiver circuitry 4172, as part of a radio unit (not shown), and interface 4190 may communicate with baseband processing circuitry 4174, which is part of a digital unit (not shown).

Antenna 4162 may include one or more antennas, or antenna arrays, configured to send and/or receive wireless signals. Antenna 4162 may be coupled to radio front end circuitry 4190 and may be any type of antenna capable of transmitting and receiving data and/or signals wirelessly. In some embodiments, antenna 4162 may comprise one or more omni-directional, sector or panel antennas operable to transmit/receive radio signals between, for example, 2 GHz and 66 GHz.

Antenna 4162, interface 4190, and/or processing circuitry 4170 may be configured to perform any receiving operations and/or certain obtaining operations described herein as being performed by a network node. Any information, data and/or signals may be received from a communication device, another network node and/or any other network equipment. Similarly, antenna 4162, interface 4190, and/or processing circuitry 4170 may be configured to perform any transmitting operations described herein as being performed by a network node. Any information, data and/or signals may be transmitted to a communication device, another network node and/or any other network equipment.

Power circuitry 4187 may comprise, or be coupled to, power management circuitry and is configured to supply the components of network node 4160 with power for performing the functionality described herein.

As a note, the WD 4110 (e.g., a communication device) may comprise similar components as those in the network node 4160, such as power circuitry, antennas, memory and processing circuitry.

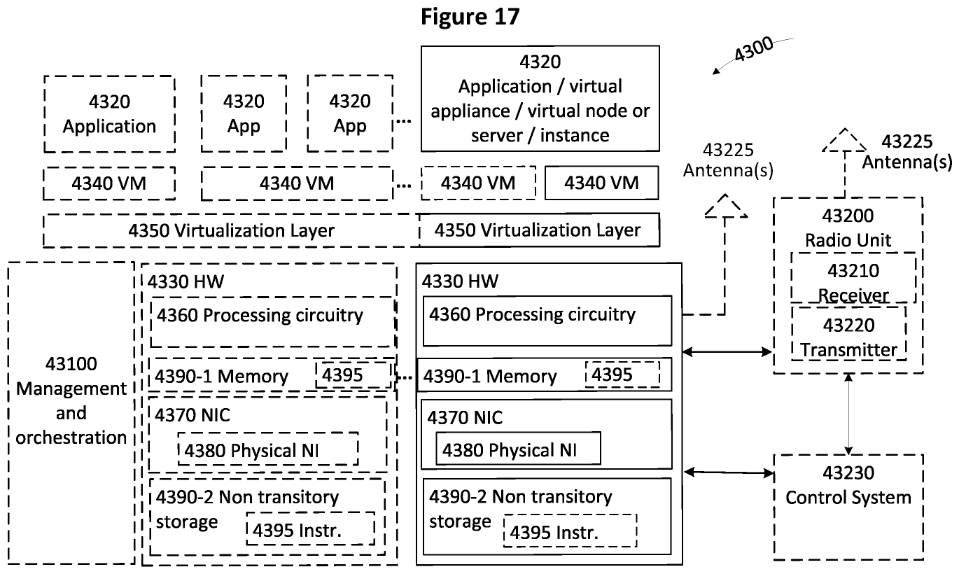

FIG. 17 is a schematic block diagram illustrating a virtualization environment 4300 in which functions implemented by some embodiments may be virtualized in accordance with some embodiments. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a communication device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 4300 hosted by one or more of hardware nodes 4330. Further, in embodiments in which the virtual node is not a radio access node or does not require radio connectivity (e.g., a core network node), then the network node may be entirely virtualized.

The functions may be implemented by one or more applications 4320 (which may alternatively be called software instances, virtual appliances, network functions, virtual nodes, virtual network functions, etc.) operative to implement some of the features, functions, and/or benefits of some of the embodiments disclosed herein. Applications 4320 are run in virtualization environment 4300 which provides hardware 4330 comprising processing circuitry 4360 and memory 4390. Memory 4390 contains instructions 4395 executable by processing circuitry 4360 whereby application 4320 is operative to provide one or more of the features, benefits, and/or functions disclosed herein.

Virtualization environment 4300, comprises general-purpose or special-purpose network hardware devices 4330 comprising a set of one or more processors or processing circuitry 4360, which may be commercial off-the-shelf (COTS) processors, dedicated Application Specific Integrated Circuits (ASICs), or any other type of processing circuitry including digital or analog hardware components or special purpose processors. Each hardware device may comprise memory 4390-1 which may be non-persistent memory for temporarily storing instructions 4395 or software executed by processing circuitry 4360. Each hardware device may comprise one or more network interface controllers (NICs) 4370, also known as network interface cards, which include physical network interface 4380. Each hardware device may also include non-transitory, persistent, machine-readable storage media 4390-2 having stored therein software 4395 and/or instructions executable by processing circuitry 4360. Software 4395 may include any type of software including software for instantiating one or more virtualization layers 4350 (also referred to as hypervisors), software to execute virtual machines 4340 as well as software allowing it to execute functions, features and/or benefits described in relation with some embodiments described herein.

Virtual machines 4340, comprise virtual processing, virtual memory, virtual networking or interface and virtual storage, and may be run by a corresponding virtualization layer 4350 or hypervisor. Different embodiments of the instance of virtual appliance 4320 may be implemented on one or more of virtual machines 4340, and the implementations may be made in different ways.

During operation, processing circuitry 4360 executes software 4395 to instantiate the hypervisor or virtualization layer 4350, which may sometimes be referred to as a virtual machine monitor (VMM). Virtualization layer 4350 may present a virtual operating platform that appears like networking hardware to virtual machine 4340.

As shown in FIG. 17, hardware 4330 may be a standalone network node with generic or specific components. Hardware 4330 may comprise antenna 43225 and may implement some functions via virtualization. Alternatively, hardware 4330 may be part of a larger cluster of hardware (e.g. such as in a data center or customer premise equipment (CPE)) where many hardware nodes work together and are managed via management and orchestration (MANO) 43100, which, among others, oversees lifecycle management of applications 4320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 4340 may be a software implementation of a physical machine that runs programs as if they were executing on a physical, non-virtualized machine. Each of virtual machines 4340, and that part of hardware 4330 that executes that virtual machine, be it hardware dedicated to that virtual machine and/or hardware shared by that virtual machine with others of the virtual machines 4340, forms a separate virtual network elements (VNE).

Still in the context of NFV, Virtual Network Function (VNF) is responsible for handling specific network functions that run in one or more virtual machines 4340 on top of hardware networking infrastructure 4330 and corresponds to application 4320 in FIG. 17.

In some embodiments, one or more radio units 43200 that each include one or more transmitters 43220 and one or more receivers 43210 may be coupled to one or more antennas 43225. Radio units 43200 may communicate directly with hardware nodes 4330 via one or more appropriate network interfaces and may be used in combination with the virtual components to provide a virtual node with radio capabilities, such as a radio access node or a base station.

In some embodiments, some signalling can be effected with the use of control system 43230 which may alternatively be used for communication between the hardware nodes 4330 and radio units 43200.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method performed by a communication device configured with a plurality of transmission configurations associated with one or more cells, each cell associated with one or more physical cell identities, PCIs, the method comprising:
receiving a signal for lower layer mobility, the signal comprising an indication of a transmission configuration to be activated from the plurality of transmission configurations; and
in response to the indicated transmission configuration, determining if a timing advance, TA, is valid or invalid.

2. The method of claim 1, further comprising obtaining the plurality of transmission configurations.

3. The method of claim 1, wherein the plurality of transmission configurations comprise a plurality of non-serving cells and a plurality of transmission configuration indicator, TCI, state configurations.

4. The method of claim 1, wherein the indication comprises at least one transmission configuration indicator, TCI, state configuration.

5. The method of claim 4, wherein the TCI state configuration comprises an association to a quasi collocation, QCL, configuration associated to a non-serving cell.

6. The method of claim 5, wherein the QCL configuration comprises an identification of a frequency and a physical cell identity, PCI.

7. The method of claim 5, wherein determining that the TA is invalid when the indicated TCI state has a QCL configuration associated to a non-serving cell.

8. The method of claim 1, wherein the signal for lower layer mobility comprises a layer 1, L1, and/or layer 2, L2, signal.

9. The method of claim 8, wherein the signal comprises a medium access control, MAC, control element (CE).

10. The method of claim 1, wherein determining if the TA is valid or invalid is based on a configuration comprising a TA validity indication.

11. The method of claim 10, wherein the configuration comprises an indication that the TA is always valid.

12. The method of claim 1, wherein determining if the TA is valid or invalid is based on a timer.

13. The method of claim 12, wherein the timer is a time alignment timer.

14. The method of claim 11, wherein determining if the TA is valid or invalid based on a timer comprises determining that the TA is valid when the timer is running and determining that the TA is invalid when the timer is not running.

15. The method of claim 13, wherein when the timer for time alignment is running, the timer for time alignment is associated to a non-serving cell associated with the indicated transmission configuration.

16. The method of claim 11, wherein the timer is a time alignment group, TAG, timer associated to a target non-serving cell.

17. The method of claim 16, wherein the TAG comprises a serving cell and a non-serving cell.

18. The method of claim 16, wherein determining if the TA is valid or invalid is based on a timer comprises determining that the TA is valid when the TAG timer is running for the TAG and determining that the TA is invalid when the TAG timer is not running for the TAG.

19. The method of claim 4, wherein determining if the TA is valid or invalid is based on a timing difference of downlink, DL, reference signals in a current TCI state configuration and the indicated TCI state configuration.

20. The method of claim 19, wherein the current TCI state configuration is associated with a CORESET pool index x, and wherein determining if the TA is valid or invalid comprises determining that the TA is valid when the indicated TCI state configuration has a PCI that is the same as the PCI of the current TCI state configuration.

21.-29. (canceled)
